(19) United States
(12) Patent Application Publication
(10) Pub. No.: US 2025/0371330 A1
(43) Pub. Date: Dec. 4, 2025

(54) FOWLER-NORDHEIM DEVICES AND METHODS AND SYSTEMS FOR CONTINUAL LEARNING AND MEMORY CONSOLIDATION USING FOWLER-NORDHEIM DEVICES

(71) Applicant: Washington University, St. Louis, MO (US)

(72) Inventors: Shantanu Chakrabartty, St. Louis, MO (US); Mustafizur Rahman, St. Louis, MO (US); Subhankar Bose, St. Louis, MO (US)

(21) Appl. No.: 18/876,550

(22) PCT Filed: Jun. 23, 2023
(86) PCT No.: PCT/US2023/068933

§ 371 Date: Dec. 18, 2024

Related U.S. Application Data
(60) Provisional application No. 63/366,937, filed on Jun. 24, 2022.
(60) Provisional application No. 63/366,964, filed on Jun. 24, 2022.

(51) Int. Cl. G06N 3/063; G06N 3/09

(52) U.S. Cl. CPC G06N 3/063; G06N 3/09

(57) ABSTRACT

A synaptic array includes a plurality of Fowler-Nordheim (FN) synapses. Each FN synapse connected to at least one other FN synapse of the plurality of FN synapses to form a network. Each FN synapse includes a pair of FN tunneling devices each including a floating gate. Each FN synapse is operable to store a synaptic weight as a differential voltage across the floating gates of its FN tunneling devices and to implement synaptic memory consolidation.

### CROSS REFERENCE TO RELATED APPLICATIONS

This application claims priority to U.S. Provisional Application Ser. No. 63/366,937, filed Jun. 24, 2022, and U.S. Provisional Application Ser. No. 63/366,964, filed Jun. 24, 2022, the contents of both of which are incorporated herein by reference in their entireties.

### STATEMENT REGARDING FEDERALLY SPONSORED RESEARCH & DEVELOPMENT

This invention was made with government support under ECCS 1935073 awarded by the National Science Foundation. The government has certain rights in the invention.

### FIELD

This application relates generally to synaptic memory consolidation, and more specifically, to methods and systems that achieve synaptic memory consolidation using Fowler-Nordheim devices.

### BACKGROUND

There is a growing evidence from the field of neuroscience and neuroscience inspired AI about the importance of implementing synapses as a complex high-dimensional dynamical system as opposed to a simple and a static storage element, as depicted in standard neural networks. This dynamical systems viewpoint has been motivated by the hypothesis that complex interactions between plethora of biochemical processes at a synapse (illustrated in FIG. 1A) produces synaptic metaplasticity and plays a key role in synaptic memory consolidation. Both these phenomena have been observed in biological synapses where the synaptic plasticity (or ease of update) can vary depending on age and task specific usage that is accumulated during the process of learning. In literature these long-term synaptic memory consolidation dynamics have been captured using different analytical models with varying degrees of complexity. One such model is the cascade model which has been shown to achieve the theoretically optimal memory consolidation characteristic for benchmark random pattern experiments. However, the physical realization of cascade models generally uses a complex coupling of dynamical states and diffusion dynamics (an example illustrated in FIG. 1B using a reservoir model), which is difficult to mimic and scale in-silico. Similar optimal memory consolidation characteristics have been reported in the context of continual learning in artificial neural networks (ANN) where synapses that are found to be important for learning a specific task are consolidated (or become rigid). As a result, when learning a new task, the synaptic weight does not significantly deviate from the consolidated weights, hence, the network seeks solutions that work well for as many tasks as possible. However, these synaptic models are algorithmic in nature and it is not clear if the optimal consolidation characteristics can be naturally implemented on the synaptic device in-silico. Also, it is not clear if the consolidation properties of the physical synaptic device can be tuned to achieve different plasticity-stability trade-offs and hence can overcome the relative disadvantages of the EWC models.

This section is intended to introduce the reader to various aspects of art that may be related to various aspects of the disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF DESCRIPTION

According to one aspect of the present disclosure, a synaptic array includes a plurality of Fowler-Nordheim (FN) synapses. Each FN synapse connected to at least one other FN synapse of the plurality of FN synapses to form a network. Each FN synapse includes a pair of FN tunneling devices each including a floating gate. Each FN synapse is operable to store a synaptic weight as a differential voltage across the floating gates of its FN tunneling devices and to implement synaptic memory consolidation.

Another aspect of this disclosure is a Fowler-Nordheim (FN) synapse for use in a synaptic array. The FN synapse includes a first FN tunneling device, a second FN tunneling device, and an input coupled to the first and second FN tunneling devices and operable to adjust a plasticity of the FN synapse in response to a signal applied to the input.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

FIG. 1A is an illustration of a biological synapse with different coupled biochemical processes that determine synaptic dynamics.

FIG. 1B isa physical realization of the cascade model that captures the consolidation dynamics using fluid in reservoirs that are coupled.

FIG. 1C is an illustration of the FN-synapse dynamics using a differential reservoir model and its state at different time-instants.

FIG. 1D is an energy-band diagram to show the implementation of the reservoir model in FIG. 1C using the physics of Fowler-Nordheim quantum-mechanical tunneling.

FIG. 1E is a micrograph of a single FN-synapse.

FIG. 1F is a micrograph of an array of FN-synaptic devices fabricated in a standard silicon process.

FIG. 2A is a random set of potentiation and depression pulses of equal magnitude and duration applied to the FN-synapse.

FIG. 2B is a bidirectional evolution of weight (W_{d}) resulting from the pulses of FIG. 2A.

FIG. 2C is the trajectory followed by the common-mode tunneling node (W_{c}) due to the pulses of FIG. 2A.

FIG. 3A graphs the measured weight update ΔW_{d} in response to different durations of the input pulses.

FIG. 3B graphs the measured weight update ΔW_{d} in response to different magnitudes of the input pulses.

FIG. 3C shows the change in the magnitude of successive weight updates (ΔW_{d}) corresponding to repeated stimulus.

FIG. 4A is a set of 10×10 randomized noise inputs fed to a network of 100 FN-synapses initialized to store an image of the number 0.

FIG. 4B is the memory evolution corresponding to the set in FIG. 4A.

FIG. 4C is a graph of signal strength for a network size of 100 synapses measured using the fabricated FN-synapse array shown in FIG. 1F.

FIG. 4D is a graph of noise strength for a network size of 100 synapses measured using the fabricated FN-synapse array shown in FIG. 1F.

FIG. 4E is a graph of SNR for a network size of 100 synapses measured using the fabricated FN-synapse array shown in FIG. 1F.

FIG. 4F is a graph of SNR comparison of the γ1 and γ2 models from FIGS. 4C-4E with the analytical model for 1,000 Monte Carlo simulations.

FIG. 5A is graph of the #patterns.retained for an FN-synapse network.

FIG. 5B is an SNR plot for the same FN-synapse network as FIG. 5A.

FIG. 6A is a graph of the overall average accuracy comparison of SGD and ADAM with FN-synapse, ADAM with EWC and Online EWC, SGD, and ADAM with conventional memory.

FIG. 6B is a distribution of the usage profile of weights in the output layer and the input layer of the FN-synapse neural network.

FIG. 6C is a graph of the overall average accuracy comparison of incremental-domain learning scenarios on the Permuted MNIST dataset using ADAM with EWC, ADAM with FN-Synapse and ADAM with conventional memory.

FIG. 6D is a graph of the overall average accuracy comparison of incremental-domain learning scenarios on the Permuted MNIST dataset using ADAGRAD with conventional memory and ADAGRAD with FN-synapse.

FIG. 7 is an equivalent circuit diagram for an FN-synapse along with the read-out mechanism used to measure W_{d}.

FIG. 8A is a graph of the stored weight as a function of patterns observed for a software model of the FN-Synapse and the hardware FN-synapse.

FIG. 8B is a graph of the deviation from FIG. 8A.

FIG. 9A is a graph of the SNR obtained from the software model of FN-synapse network.

FIG. 9B is a graph of the memory retrieval signal S(n) obtained from the software model of FN-synapse network.

FIG. 9C is a graph of the noise v(n) obtained from the software model of FN-synapse network.

FIG. 9D is a graph illustrating the effect on the SNR of the software model when the pulse-width of the input pulse is varied.

FIG. 9E is a graph illustrating the effect on the signal of the software model when the pulse-width of the input pulse is varied.

FIG. 9F is a graph illustrating the effect on the noise of the software model when the pulse-width of the input pulse is varied.

FIG. 9G is a graph illustrating the effect on the SNR of the software model when the magnitude of the input pulse is varied.

FIG. 9H is a graph illustrating the effect on the signal of the software model when the magnitude of the input pulse is varied.

FIG. 9I is a graph illustrating the effect on the noise of the software model when the magnitude of the input pulse is varied.

FIG. 9J is a graph illustrating the effect on the SNR of the software model when the size of the network is varied.

FIG. 9K is a graph illustrating the effect on the signal of the software model when the size of the network is varied.

FIG. 9L is a graph illustrating the effect on the noise of the software model when the size of the network is varied.

FIG. 10A is a graph that compares the output of the probabilistic FN-synapse model and the deterministic behavioral model.

FIG. 10B shows the corresponding deviation in FIG. 10A.

FIG. 10C graphs the SNR of the network for different tunneling regions.

FIG. 10D is a graph of the update size in terms of numbers of electrons per update for a first condition shown in FIG. 10C.

FIG. 10E is a graph of the update size in terms of numbers of electrons per update for a second condition shown in FIG. 10C.

FIG. 10F is a graph of the update size in terms of numbers of electrons per update for a third condition shown in FIG. 10C.

FIG. 11A is graph of accuracy of an FN-synapse based network over five tasks for various initial plasticity's of the FN-synapses.

FIG. 11B is a graph of the weights stored in the synapses of the network for the tasks in FIG. 11A using a first initial plasticity.

FIG. 11C is a graph of the weights stored in the synapses of the network for the tasks in FIG. 11A using a second initial plasticity.

FIG. 11D is a graph of the weights stored in the synapses of the network for the tasks in FIG. 11A using a third initial plasticity.

FIG. 12A is an example architecture of a neural network.

FIG. 12B shows the evolution of corresponding weights between layer 1 and 2 of the network in FIG. 12A over five successive tasks.

FIG. 12C shows the evolution of corresponding weights between layer 2 and 3 of the network in FIG. 12A over five successive tasks.

FIG. 12D is shows the evolution of corresponding weights between layer 3 and 4 of the network in FIG. 12A over five successive tasks.

FIG. 13A is a graph of the accuracy of the network in FIG. 12A for a first task when trained according to different learning and consolidation approaches.

FIG. 13B is a graph of the accuracy of the network in FIG. 12A for a second task when trained according to different learning and consolidation approaches.

FIG. 13C is a graph of the accuracy of the network in FIG. 12A for a third task when trained according to different learning and consolidation approaches.

FIG. 13D is a graph of the accuracy of the network in FIG. 12A for a fourth task when trained according to different learning and consolidation approaches.

FIG. 13E is a graph of the accuracy of the network in FIG. 12A for a fifth task when trained according to different learning and consolidation approaches.

FIG. 14A is graph comparing the accuracy of different configurations of a neural network like in FIG. 12A at completing five tasks when trained with SGD.

FIG. 14B is graph comparing the accuracy of different configurations of a neural network like in FIG. 12A at completing five tasks when trained with ADAM.

FIG. 15A is a graph showing the effect of a 5% mismatch in device characteristics across synapses on the SNR of an FN-synapse network of 10,000 synapses.

FIG. 15B is a graph comparing the accuracy of three different neural networks including one with 5% mismatch in device characteristics.

FIG. 16 is a graph comparing the noise of FN-synapse networks composed of 1000 synapses following different synaptic models when exposed to 2000 patterns.

FIG. 17 is a graph of SNR of an initially empty network of 1000 synapses with different modulation profiles when exposed to 2000 patterns.

FIG. 18A is a graph of the SNR in the steady state for an FN-synapse network of size N=1000 with different magnitude of γ.

FIG. 18B is a graph of the steady-state SNR of various updates for FN-synapse networks of different sizes when exposed to subsequent updates.

FIG. 18C is a graph of memory lifetime as a function of network size.

Corresponding reference characters indicate corresponding parts throughout the drawings.

### DETAILED DESCRIPTION

This disclosure relates generally to synaptic memory consolidation, and more specifically, to methods and systems that achieve synaptic memory consolidation using Fowler-Nordheim devices. Additional details and description of Fowler-Nordheim devices that may be used in embodiments of this disclosure is found in International Patent Publication No. WO2022/094038, U.S. Pat. No. 11,041,764, and U.S. Patent Application Publication No. 2023/0046551, the entire disclosures of which are hereby incorporated herein by reference in their entireties.

For artificial synapses whose strengths are assumed to be bounded and can only be updated with finite precision, achieving optimal memory consolidation using primitives from classical physics leads to synaptic models that are too complex to be scaled in-silico. Described herein are examples of differential devices that operate using the physics of Fowler-Nordheim (FN) quantum-mechanical tunneling can achieve tunable memory consolidation characteristics with different plasticity-stability trade-offs. Prototype FN-synapse array were fabricated in a standard silicon process and used to verify the optimal memory consolidation characteristics and used for estimating the parameters of an FN-synapse analytical model. The analytical model was then used for large-scale memory consolidation and continual learning experiments. Compared to other physical implementations of synapses for memory consolidation, the operation of the FN-synapse is near-optimal in terms of the synaptic lifetime and the consolidation properties. A network comprising FN-synapses outperforms a comparable elastic weight consolidation (EWC) network for some benchmark continual learning tasks. With an energy footprint of femtojoules per synaptic update, the example FN-synapses provide an energy-efficient approach for implementing both synaptic memory consolidation and continual learning on a physical device.

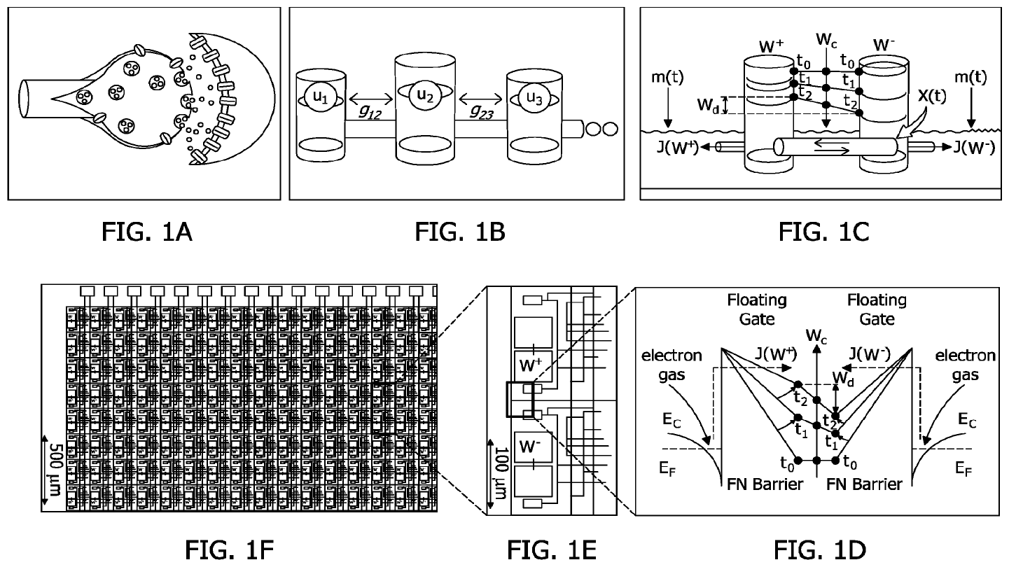

Examples of this disclosure include a simple differential device that operates using the physics of Fowler-Nordheim (FN) quantum-mechanical tunneling that can achieve tunable synaptic memory consolidation characteristics similar to the algorithmic consolidation models. The operation of the synaptic device, referred to herein as the FN-synapse, can be understood using a reservoir model as shown in FIG. 1C). Two reservoirs with fluid levels W⁺ and W⁻ are coupled to each other using a sliding barrier X. The barrier is used to control the fluid flow from the respective reservoirs into an external medium. The respective flows, which are modeled by functions J(W⁺) and J(W⁻), at time-instant t re modulated by the position of the sliding barrier X(t) and the level of fluid in the external reservoir m(t). In this reservoir model, the synaptic weight is stored as W_{d}=½(W⁺−W⁻) whereas W_{c}=½(W⁺+W⁻) serves as an indicator of synaptic usage with respect to time.

For a synapse based on a general differential reservoir model [without making assumptions on the nature of the flow function J(·)] the synaptic weight Wd evolves in response to the external input X(t) according to the coupled differential equation

$$\frac{d {W}_{d}}{d t} = − r ( t ) {W}_{d} + X ( t ) \qquad ( 1 )$$

$$where$$

$$r ( t ) = \frac{{d}^{2} {W}_{c}}{d {t}^{2}} {( \frac{d {W}_{c}}{d t} )}^{- 1} \qquad ( 2 )$$

is a time varying decay function that models the dynamics of the synaptic plasticity as a function of the history of synaptic activity (or its usage). The usage parameter W_{c} evolves according to

$$\frac{{dW}_{c}}{dt} = - J ( {W}_{c} ) + m ( t ) \qquad ( 3 )$$

based on the functions J(·) and m(t). Equations (1)-(3) show that the weight W_{d} update does not directly depend on the non-linear function J(·) but implicitly through the common-mode W_{c}. Furthermore, Equation (1) conforms to the weight update equation reported in the EWC model where it has been shown that if r(t) varies according to the network Fisher information metric, then the strength of a stored pattern or memory (typically defined in terms of signal-to-noise ratio) decays at an optimal rate of 1/\sqrt{t} when the synaptic network is subjected to random, uncorrelated memory patterns. If the objective is to maximize the operational lifetime of the synapse, then equating the time-evolution profile in Equation (2) to r(t)≈ [symbol] (1/t) leads to an optimal J(·) of the form J(V)∝V² exp(−β/V) where β is a constant. The expression for J(V) matches the expression for a Fowler-Nordheim (FN) quantum-mechanical tunneling current indicating that optimal synaptic memory consolidation could be achieved on a physical device operating on the physics of FN quantum-tunneling.

FIGS. 1A-1F illustrate on-device memory consolidation using FN-synapses. FIG. 1A is an illustration of a biological synapse with different coupled biochemical processes that determine synaptic dynamics. FIG. 1B is a physical realization of the cascade model reported that captures the consolidation dynamics using fluid in reservoirs uk that are coupled through parameters gkj. FIG. 1C is an illustration of the FN-synapse dynamics using a differential reservoir model and its state at time-instants t0, t1, and t2. FIG. 1D is an energy-band diagram to show the implementation of the reservoir model in FIG. 1C using the physics of Fowler-Nordheim quantum-mechanical tunneling where a single synaptic element (as show in FIG. 1E) which stores the weight Wd as the differential charge stored between each tunneling junction, i.e.,

$${W}_{d} = \frac{{W}^{+} - {W}^{-}}{2}$$

and the common-mode tunneling voltage W_{c} as the average of the individual charges, i.e.,

$${W}_{c} = \frac{{W}^{+} + {W}^{-}}{2} .$$

FIG. 1E is a micrograph of a single FN-synapse. FIG. 1F is a micrograph of an array of FN-synaptic devices fabricated in a standard silicon process.

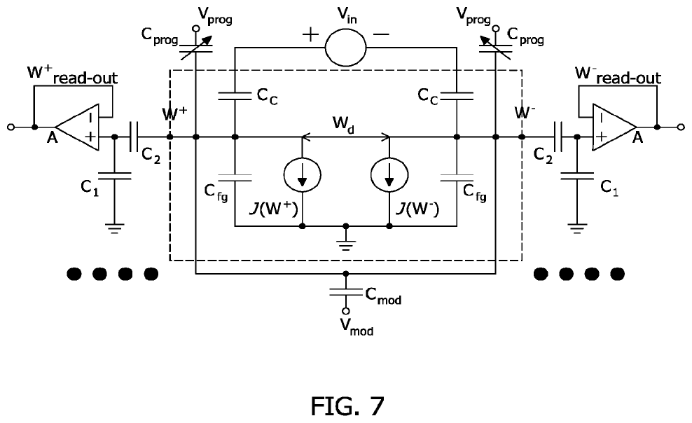

An array of FN-synapses was fabricated and FIGS. 1D and 1E show the micrograph of the fabricated prototype. The mapping of the differential reservoir model using the physical variables associated with FN quantum tunneling is shown below and FIG. 1F shows the mapping using an energy-band diagram. The tunneling junctions have been implemented using polysilicon, silicon-di-oxide, and n-well layers, where the silicon-di-oxide forms the FN-tunneling barrier for electrons to leak out from the n-well onto a polysilicon layer. The polysilicon layer forms a floating-gate where the initial charge can be programmed using a combination of hot-electron injection or quantum-tunneling. The synaptic weight is stored as a differential voltage W_{d}=½(W⁺−W⁻) across two floating-gates as shown in FIG. 1F. The voltages on the floating-gates W⁺ and W⁻ at any instant of time are modified by the differential signals ±½ X(t) that are coupled onto the floating-gates. The dynamics for updating W⁺ and W⁻ are determined by the respective tunneling currents J(·) which discharge the floating-gates. FIG. 7, includes the complete equivalent circuit for the FN-synapse along with the read-out mechanism used to measure W_{d}. The presence of additional coupling capacitors in FIG. 7 provides a mechanism to inject a common-mode modulation signal m(t) into the FN-synapse. It will be shown that m(t) can be used to tune the memory consolidation characteristics of the FN-synapse array to achieve memory capacity similar to or better than the cascade consolidation models (with different degrees of complexities) or the task-specific synaptic consolidation corresponding to the EWC model.

### FN-Synapse Characterization

A first example helps to understand the metaplasticity exhibited by FN-synapses and how the synaptic weight and usage change in response to an external stimulation. Techniques to initialize the charge stored on the floating-gates in an FN-synapse can be found below. The tunneling barrier thickness in FN-synapse prototype shown in FIGS. 1D-1E was chosen to be greater than 12 nm, which makes the probability of direct tunneling of electrons across the barrier to be negligible. Also, when the electric potential of the tunneling nodes W⁺ and W⁻ are set to be less than 5V, the probability of FN tunneling of electrons across the barrier becomes negligible. In this state, the FN-synapse behaves as a standard nonvolatile memory storing a weight proportional to W⁺ and W⁻. To increase the magnitude of the stored weight a differential input pulse ±½ X is applied across the capacitors coupled to the floating gates. The electric potential of the floating-gate W⁻ is increased beyond 7.5V where the FN tunneling current J(W⁻) is now significant. At the same time the electric potential of the floating-gate W⁺ is also pushed higher with W⁻>W such that FN tunneling current J(W⁺)<J(W⁻). As a result, the W⁻ node discharges at a rate that is faster than the W⁺ node. After the input pulse is removed, the potential of both W⁺ and W⁻ are pulled below 5V and hence the FN-synapse returns to its non-volatile state.

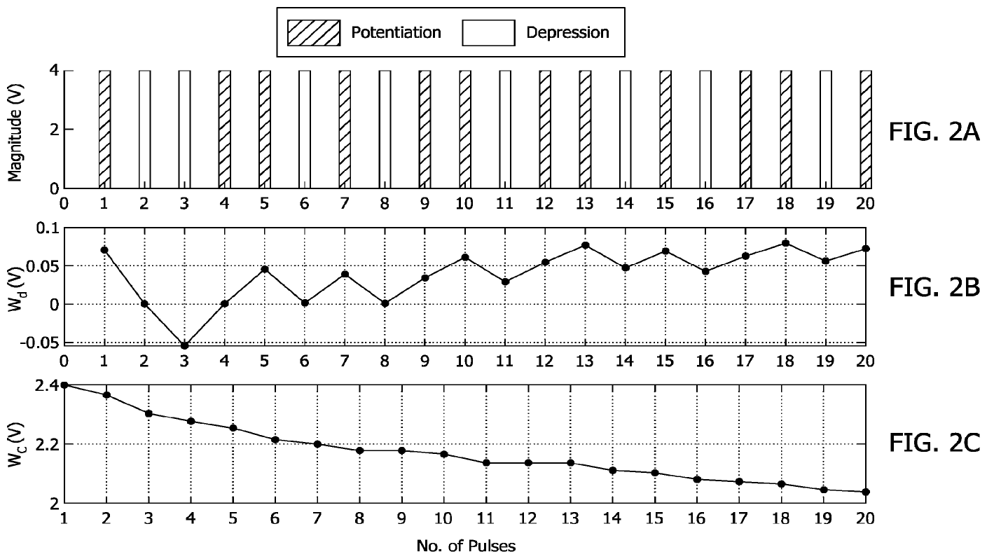

FIGS. 2A-2C show the experimental weight evolution of FN-synapse. FIG. 2A shows a random set of potentiation and depression pulses of equal magnitude and duration applied to the FN-synapse. This produces the bidirectional evolution of weight (W_{d}) shown in FIG. 2B and the corresponding trajectory followed by the common-mode tunneling node (W_{c}) shown in FIG. 2C. Specifically, FIGS. 2A-2C show the measured responses which shows that an FN-synapse can store both the weight and the usage history. When a series of potentiation and depression pulses of equal magnitude and duration is applied to the FN-synapse, as shown in FIG. 2A, the weight stored W_{d} evolves bidirectionally (like a random walk) due to the input pulses (see FIG. 2B). Meanwhile, the common-mode potential W_{c} decreases monotonically with the number of input pulses irrespective of the polarity of the input, as shown in FIG. 2C. Therefore, W_{c} reliably tracks the usage history of the FN-synapse whereas W_{d} stores the weight of the synapse.

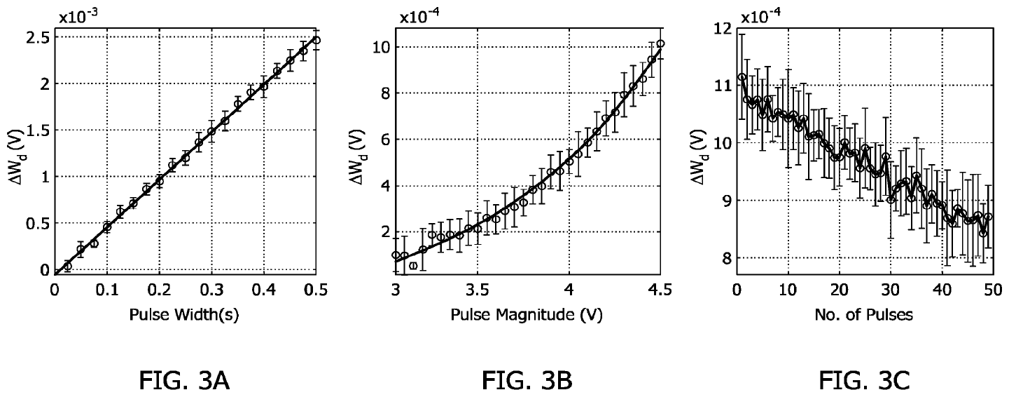

FIGS. 3A-3C show the experimental characterization of a single FN-synapse. FIG. 3A shows the dependence of change in magnitude of weight with change in pulse-width which follows a linear trajectory defined by y=mx+c (where m=0.005136 and c=−6.227×10⁻⁵). FIG. 3B shows dependence on pulse magnitude of the input pulse which follows an exponential trajectory defined by y=c×exp(ax+b)+d (where a=1, b=−6.611, c=0.009959 and d=−0.0002142). FIG. 3C shows change in the magnitude of successive weight updates (ΔW_{d}) corresponding to repeated stimulus. More specifically, FIGS. 3A and 3B show the measured weight update ΔW_{d} in response to different magnitudes and duration of the input pulses. For this experiment the common mode W_{c}=½(W⁺+W⁻) is held fixed. In FIG. 3A, we can observe that for a fixed magnitude of input voltage pulses (=4V), ΔWd changes linearly with pulse width. FIG. 3B shows that the updated ΔW_{d} changes exponentially with respect to the magnitude of the input pulses (duration=100 ms). Thus, the results show that pulse width modulation or pulse density modulation provides an accurate control over the synaptic updates. Furthermore, in regard to energy dissipation per synaptic update, pulse width modulation is also more attractive than using pulse magnitude variation. The energy required to write each time on FN-synapse can be estimated by measuring the energy drawn from the differential input source X in FIG. 7 to charge the coupling capacitor C_{c} and is given by

$${E}_{write} = \frac{1}{2} {{C}_{c} ( X )}^{2} \qquad ( 4 )$$

This means that using smaller pulse magnitude accompanied by longer pulse width is generally preferable than the other way around in the context of write energy dissipation for the same desired change in weight. However, this would come at a cost of slower writing speed. Therefore, a trade-off exists. For the fabricated FN-synapse prototype, the magnitude of the coupling capacitor C_{c} is approximately 200 fF which leads to 400 fJ for an input voltage pulse change of 2V across C_{c}. For the differential input voltage pulse of 4V a total of 800 fJ of energy was dissipated for each potentiation and depression of the synaptic weights. When the common-mode We is not held fixed, irrespective of whether the weight W_{d} is increased or decreased (depending on the polarity of the input signal), the common-mode always decreases. Thus, W_{c} could serve as an indicator of the usage of the synapse. FIG. 3C shows the metaplasticity exhibited by an FN-synapse where ΔW_{d} was measured as a function of usage by applying successive potentiation input pulses of constant magnitude (4V) and width (100 ms). FIG. 3C shows that when the synapse is modulated with same excitation successively, the amount of weight update decreases monotonically with increasing usage, similar to the response illustrated in FIGS. 1C and 1F.
FN-Synapse Network Capacity and Memory Lifetime without Plasticity Modulation

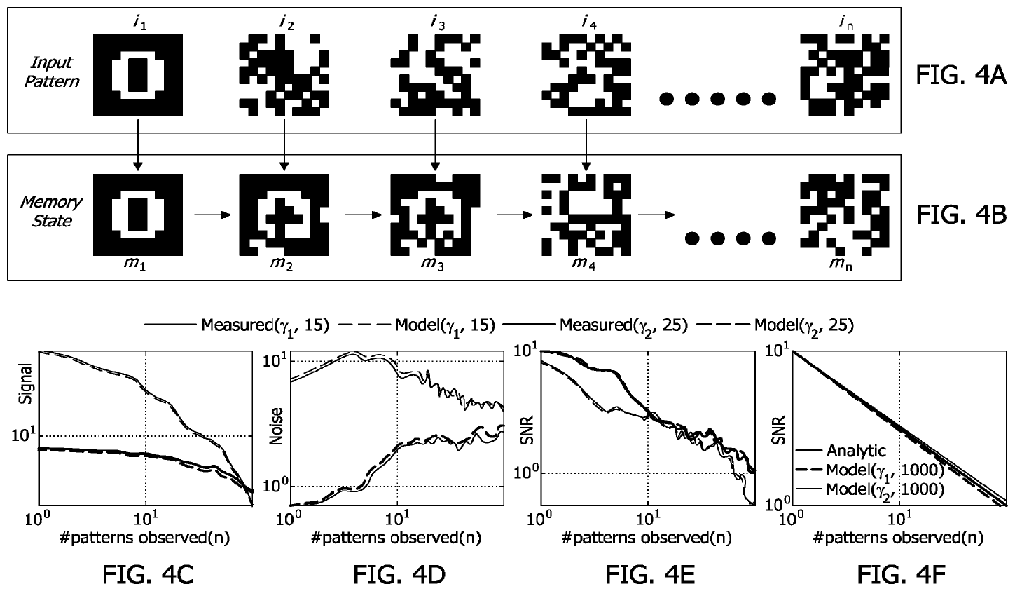

The next set of examples will help to understand the memory consolidation characteristics for an FN-synapse array that is excited using a random binary input pattern (potentiation or depression pulses). This type of benchmark used extensively in memory consolidation studies since analytical solutions exist for limiting cases which can be used to validate and to compare the experimental results. A network comprising of N FN-synapses is first initialized to store zero weights (or equivalently W⁺=W⁻). New memories were presented as random binary patterns (N dimensional random binary vector) that are applied to the N FN-synapses through either potentiation or depression pulses. Each synaptic element was provided with balanced input, i.e., equal number of potentiation and depression pulses. The goal of this is to track the strength of a memory that is imprinted on this array in the presence of repeated new memory patterns. This is illustrated in FIGS. 4A and 4B where an initial input pattern (a 2D image of the number “0” comprising of 10×10 pixels) is written on a memory array. The array is then subjected to images of noise patterns that are statistically uncorrelated to the initial input pattern. It can be envisioned that as additional new patterns are written to the same array, the strength of a specific memory (here, of the image “0”) will degrade. This degradation was quantified in terms of signal-to-noise ratio (SNR). If n denotes the number of new memory patterns that have been applied to an empty FN-synapse array (i.e., initial weight stored on the network is zero), for the p^{th} update the retrieval memory signal S(n, p) power, the noise v(n, p) power and the SNR (n,p) can be expressed analytically as

$${S}^{2} ( n , p ) = \frac{1}{{( n + γ )}^{2}} ; \text{} {v}^{2} ( n , p ) = \frac{n}{{N ( n + γ )}^{2}} ; \qquad ( 5 )$$

$$SNR ( n , p ) = \sqrt{\frac{N}{n}} .$$

where γ>0 is a device parameter that depends on the initialization condition, material properties and duration of the input stimuli.

Equation (5) shows that the initial SNR is \sqrt{N} and the SNR falls off according to a power-law decay with a slope of

$$\frac{1}{\sqrt{n}} .$$

A specific memory pattern is considered to be retained as long as its SNR exceeds a predetermined threshold. Therefore, according to equations (5), the network capacity and memory lifetime for FN-synapse scales linearly with the size of the network N, when the initial weight across all synapses is zero. The analytical expressions in equation (5) were verified for a network size of N=100 using results measured from the FN-synapse chipset. Details of the hardware experiment is provided below.

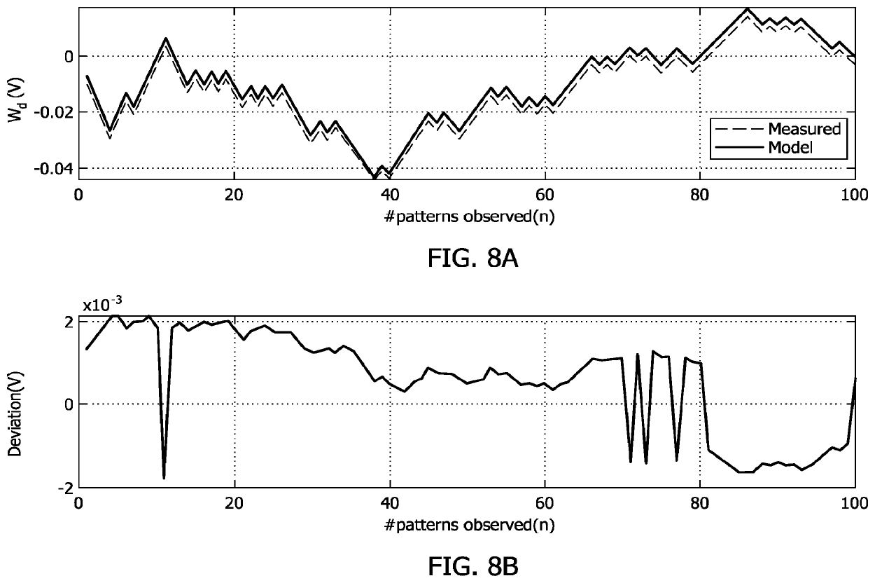

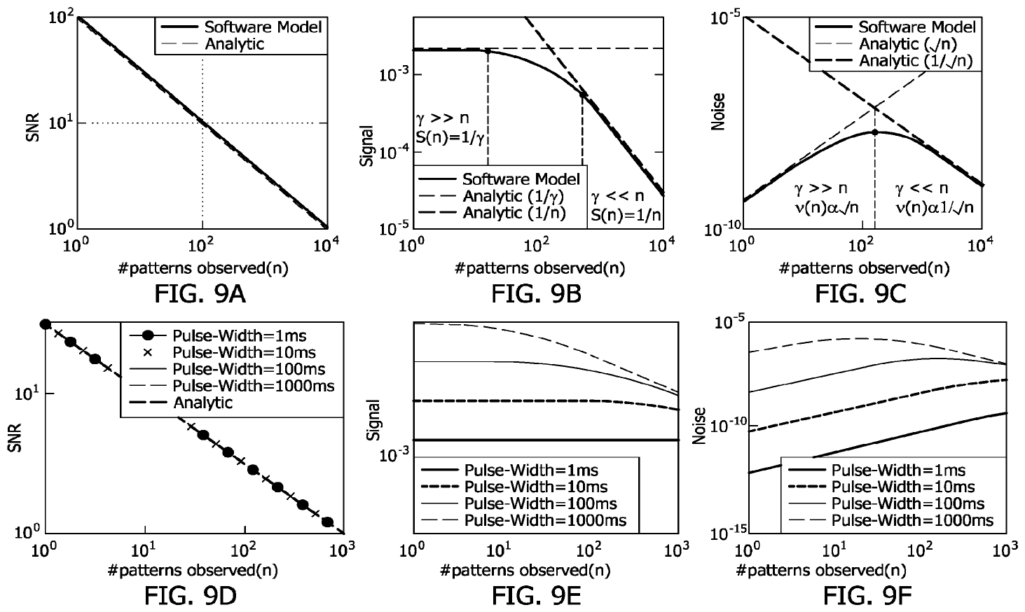

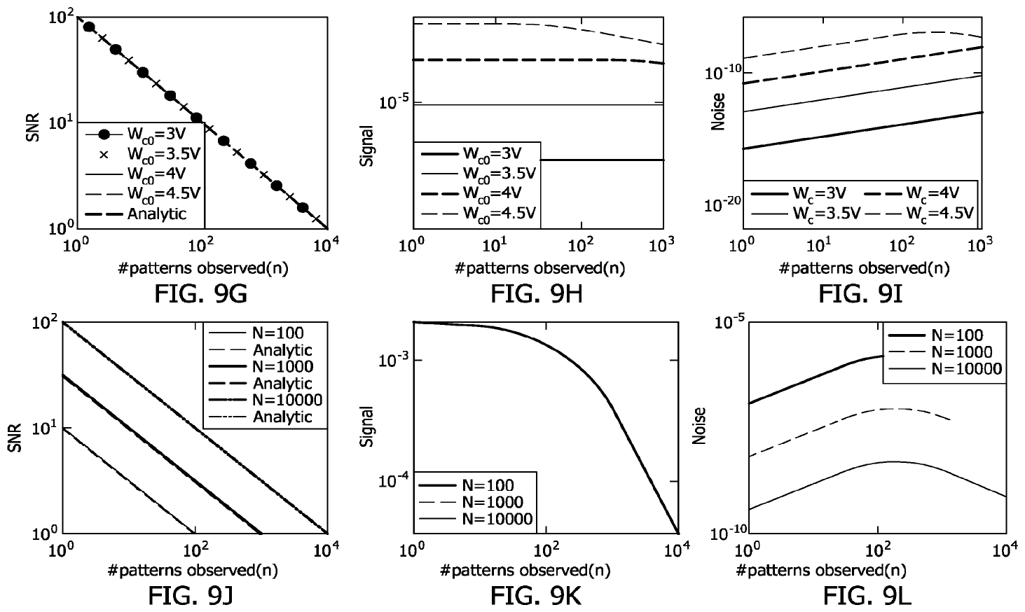

FIGS. 4A-4F compare measured and simulated memory consolidation for an empty FN-synapse network. FIG. 4A shows a set of 10×10 randomized noise inputs fed to a network of 100 FN-synapses initialized to store an image of the number 0 and FIG. 4B is the corresponding memory evolution. FIGS. 4C-4E graphs of signal strength (FIG. 4C), noise strength (FIG. 4D), and SNR (FIG. 4E) for a network size of 100 synapses measured using the fabricated FN-synapse array shown in FIG. 1F for 25 (for γ1) and 15 (for γ2) Monte-Carlo runs. FIG. 4F is a graph of SNR comparison of the γ1 and γ2 models with the analytical model for 1,000 Monte Carlo simulations. The legends associated with the plots are specified as (γ, Number of Monte-Carlo runs). All of these results correspond to the behavior of an empty FN-synapse network. As noted, FIGS. 4C-4E show the SNR, noise and the retrieval signal obtained from the fabricated FN-synapse network for two different values of γ. The SNR obtained from the hardware results conform to the analytical expressions relatively well. The slight differences can be attributed to the Monte-Carlo simulation artifacts (only 25 and 15 iterations were carried out). In FIG. 9, these analytic expressions are verified using a behavioral model of the FN-synapse which mimics the hardware prototype with great accuracy (as shown in FIG. 8). Details on the derivation of FN-synapse model is provided below. The simulated results in FIGS. 4C-4E verifies that results from the software model can accurately track the hardware FN-synapse measurements for both values of γ when subjected to the same stimuli. Therefore, FN-synapse and its behavioral model can be used interchangeably. The results in FIG. 4F also show that when the number of iterations on the Monte-Carlo simulation is increased (e.g., to 1000 iterations), the simulated SNR closely approximates the analytic expression. This verifies that hardware FN-synapse is also capable of matching the optimal analytic consolidation characteristics. FIG. 3C shows the measured evolution of weights stored in the FN-synapse where initially the weights grow quickly but after a certain number of updates settle to a steady value irrespective of new updates. This implies that the synapses have become rigid with an increase in its usage. This type of memory consolidation is also observed in EWC models which has been used for continual learning. However, note that unlike EWC models that need to store and update some measure of Fisher information, whereas here the physics of the FN-synapse device itself can achieve similar memory consolidation without any additional computation.

### Plasticity Modulation of FN-Synapse Models

The plasticity of FN-synapses can be adjusted to mimic the consolidation properties of both EWC and steady-state models (such as cascade models). While EWC models only allow for retention of old memories, steady state/cascade models allow for both memory retention and forgetting. As a result, these models avoid blackout catastrophe whereas an EWC network is unable to retrieve any previous memories or store new experiences as the network approaches its capacity. Steady state models allow the network to gracefully forget old memories and continue to remember new experiences indefinitely.

For an FN-synapse network, a coupling capacitor in each synapse (shown in FIG. 7) which is driven by a global voltage signal V_{mod}(t) (which produces

$$m ( t ) = \frac{{dv}_{m o d} ( t )}{dt} )$$

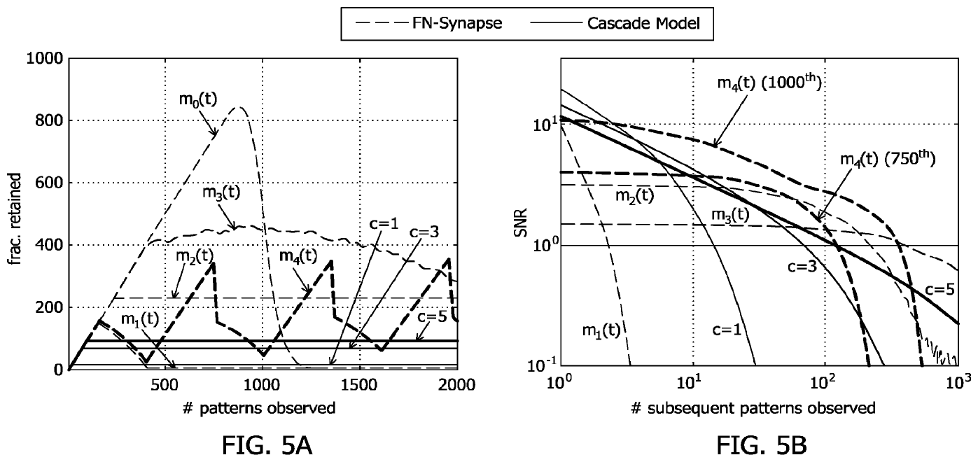

can control the plasticity of the FN-synapse to mimic the characteristics of a steady state model. Details of the FN-synapse achieving a steady state response are provided below. To understand and compare the blackout catastrophe in FN-synapse models with a steady-state model, e.g., the cascade model, the metric #patterns.retained (sometimes referred to herein as frac.retained) is defined as the total number of memory patterns whose SNR exceeds 1 at any given point of time. The #patterns.retained for FN-synapse network with modulation profiles m₀(t), m₁(t), m₂(t), m₃(t), and m₄(t) of size N=1,000 is shown in FIG. 5A together with those for cascade models of different levels of complexity (denoted by c=1, . . . , 5). In order to calculate the #patterns.retained the SNR resulting from each stimulus was calculated and tracked at every observation to determine the number of such stimuli that had a corresponding SNR greater than unity. The profiles of m₁(t), m₂(t), and m₃(t) are produced by changing V_{mod}(t) at each update as three quarter, half, and quarter of the average of ΔW_{d} across all the synapses during the latest update, respectively, while m₀(t) is achieved through a constant voltage signal V_{mod}(t). In FIG. 5A, the FN-synapse network with m₀(t) can be seen to forget all observed patterns in addition to not forming any new memories as #patterns.retained goes to zero as the network capacity is reached starting from an empty network. Whereas, in the case for FN-synapse under m₁(t) and m₂(t) modulation profile the #patterns.retained reaches a finite value similar to that of the cascade models. This indicates that the FN-synapse network when subjected to plasticity modulation profiles continues to form new memory while gracefully forgetting the old ones. For the m₃(t) modulation profile the network is slowly evolving and yet to reach the steady state condition within 2000th update. The FN-synapse network under the m₄(t) modulation profile, which switches between m₀(t) and m₁(t) periodically, is in an oscillatory steady-state with the same periodicity as the modulation profile itself. However, note that the network does not suffer from blackout catastrophe and has a variable capacity. This shows that the capacity of the FN-synapse network can also be tuned to the specificity of different applications. From the figure, we also observe that the steady state network capacity for m₂(t) modulation profile is higher than that of cascade models. Note here that network capacity for cascade models may be increased by increasing the complexities of the synaptic model. Nevertheless, we find that network capacity for FN-synapse is comparable to cascade models of moderate complexities.

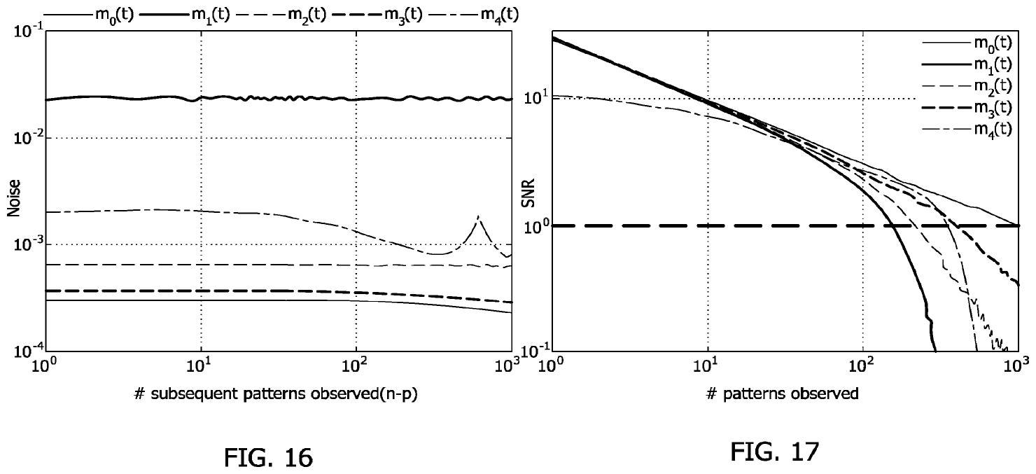

The plasticity modulation may be further understood through the SNR for patterns introduced to a non-empty network. For this example, the 1000th pattern observed by the network of N=1,000 synapse was tracked. FIG. 5B shows the SNR of this pattern under m₁(t)−m₄(t) modulation profile along with cascade models of various complexity. Note that the x-axis now represents the age of the stimulus, i.e., number of patterns observed after the tracked pattern. For the modulation profile m₁(t) the initial SNR is large, comparable to that of cascade models, but the SNR falls off quickly indicating high plasticity. Whereas, for modulation profile m₂(t) and m₃(t) the initial SNR is smaller than m₁(t) but it falls off at a much later time similar to cascade models with high complexities. These SNR profiles for FN-synapse model with modulation m₁(t)−m₃(t) are similar to that of a constant weight decay synaptic model used in deep learning neural network as a regularization method. On the other hand, the SNR profile for the 1000th pattern under m₄(t) modulation has both high initial SNR and a large lifetime. However, from FIG. 5B, the network is in an oscillatory state which indicates that this profile is specific to the 1000th pattern, and if any other pattern was tracked, the SNR profile would be different (for reference the SNR tracked for the 750th update is also shown). This is not the case for the cascade models which would consistently have similar SNR profiles irrespective of the pattern that is tracked. Nevertheless, this SNR profile for the FN-synapse model would repeat itself corresponding to the periodicity of the modulation profile. This suggests that the amount of plasticity and memory lifetime for the FN-synapse model is readily tunable and depends on the amount of modulation provided to the network. The synaptic strength of FN-synapse is bounded similarly to that of the cascade models. This can be observed in FIG. 16 which shows that the variance in retrieval signal (Noise) of an FN-synapse network with both constant modulation and time-varying modulations remains bounded. In FIG. 16, the noise of FN-synapse networks composed of 1000 synapses following different synaptic models when exposed to 2000 patterns are compared. Furthermore, FIG. 17 shows that plasticity modulation indeed introduces a forgetting mechanism as the SNR for different modulation profiles (when tracked from an empty network) starts to fall off earlier than the one without modulation. Specifically, FIG. 17 graphs SNR of an initially empty network of 1000 synapses with different modulation profiles m(t) when exposed to 2000 patterns.

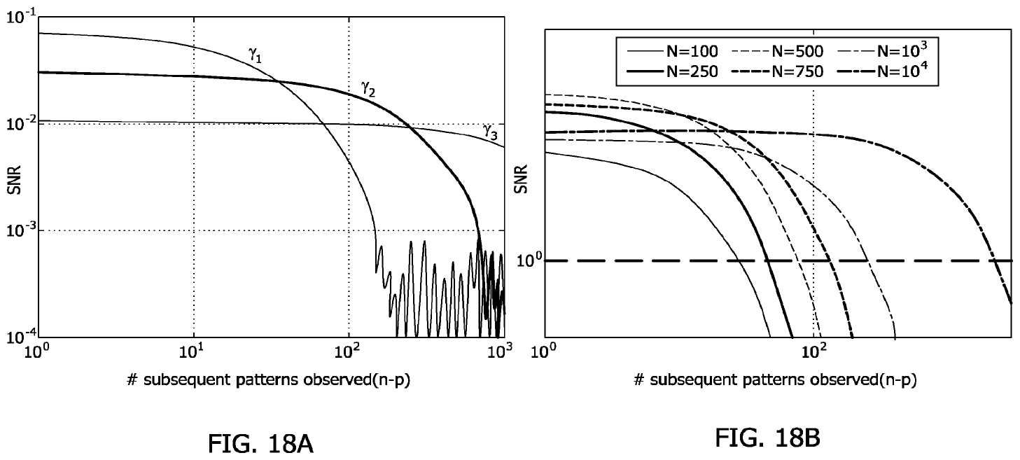

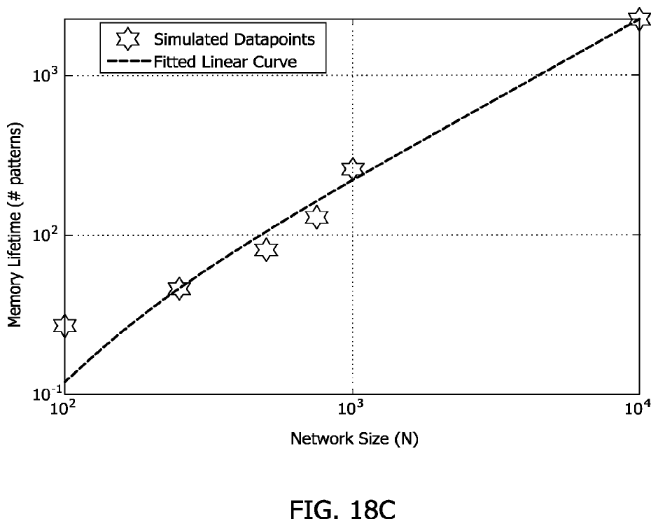

In addition to different modulation profile, the plasticity-lifetime tradeoff of the FN-synapse model can also be achieved by varying the parameter γ as shown in FIG. 18. FIG. 18A shows the SNR in the steady state for an FN-synapse network of size N=1000 with different magnitude of γ where γ3>γ2>γ1 under modulation profile of m₂(t). The magnitude of γ was varied by using three different input modulation pulse width Δt. In FIG. 18B, tracking the steady-state SNR of various updates (p) for FN-synapse networks of different sizes (N) with modulation profile m₂(t) when exposed to subsequent updates is shown. FIG. 18C shows the corresponding memory lifetime which scales linearly according to y=mx+c, where m=0.2264 and c=−10.46. Therefore, our synaptic models can exhibit memory consolidation properties similar to both EWC and steady-state models while being physically realizable and scalable for large networks.

### Continual Learning Using FN-Synapse

The performance of FN-synapse neural network for a benchmark continual learning task was evaluated. A fully connected neural network with two hidden layers was trained sequentially on multiple supervised learning tasks. Details of the neural network architecture and training are given in below. The network was trained on each task for a fixed number of epochs and after the completion of its training on a particular task tₙ, the dataset from tₙ was not used for the successive task tₙ+1.

The aforementioned tasks were constructed from the Modified National Institute of Standards and Technology (MNIST) dataset, to address the problem of classifying handwritten digits in accordance with schemes popularly used in several continual-learning literature. Also known as incremental domain learning using split-MNIST dataset, each task of this continual learning benchmark dictates the neural network to be trained as binary classifier which distinguishes between a set of two hand-written digits, i.e. the network is first trained to distinguish between the set [0, 1] as t₁ and is then trained to distinguish between [2, 3] in t₂, [4, 5] in t₃, [6, 7] in t₄ and [8, 9] in t₅. Thus, the network acts as an even-odd number classifier during every task.

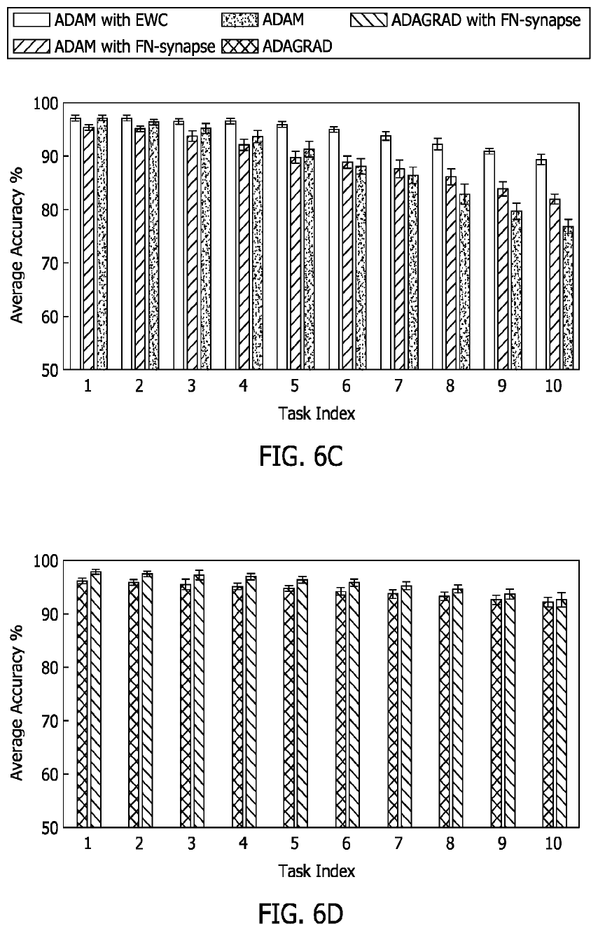

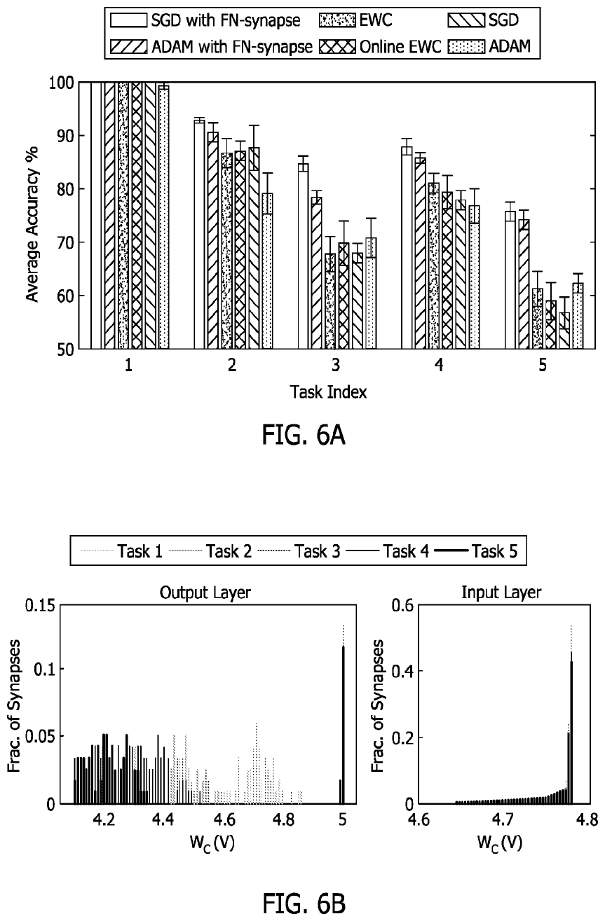

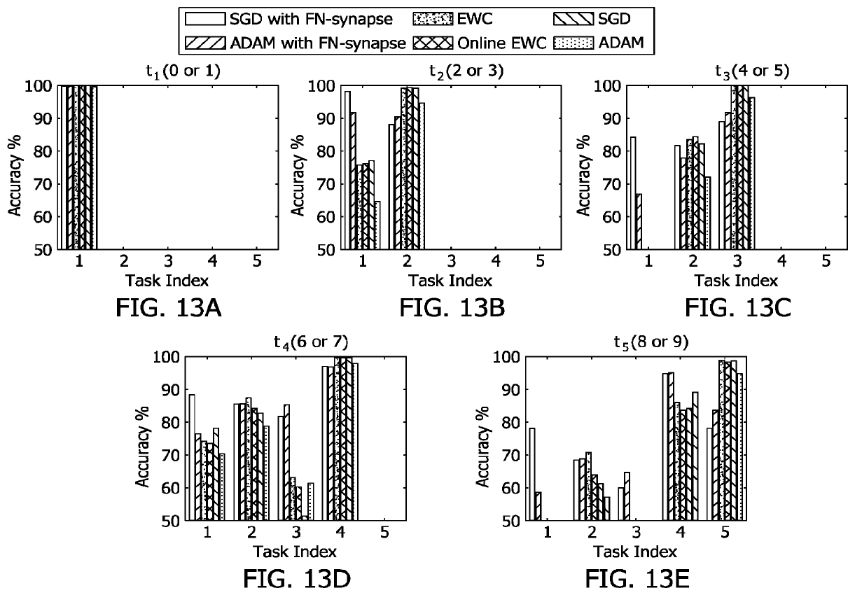

FIGS. 13A-E compare the task-wise accuracy of networks trained with different learning and consolidation approaches. Note here that the absence of a data-point corresponding to a particular approach indicates that the accuracy obtained is below 50%. All the approaches taken into consideration perform equally well at learning t₁ as illustrated in FIG. 13A. However, as the networks learn t₂ (see FIG. 13B), the performance of both EWC architectures degrade for task t₁ as do the networks with conventional memory using SGD and ADAM. The FN-synapse based networks on the other hand retain the accuracy of task t₁ far better in comparison. This advantage in retention comes at the cost of learning t₂ marginally poorer than others. This trend of retaining the older memories or tasks far better than other approaches continues in successive tasks. Particularly, if we consider the retention of t₁ when the networks are trained on t₃ (see FIG. 13C), it can be observed that it is only the FN-synapse based networks that retain t₁ while others fall below the 50% threshold. Similar trends can be observed in FIGS. 13D and 13E. There are a few instances during the five tasks where the EWC variants and SGD with conventional memory marginally outperform or match the FN-synapse in terms of retention. However, if the overall average accuracy of all these approaches are compared (see FIG. 6A), it is clearly evident that both the FN-synapse networks significantly outperform the others. It is also worth noting here that even when a network equipped with FN-synapse is trained using a computationally-inexpensive optimizer such as SGD, it shows remarkably superior performance than highly computationally-expensive approaches such as ADAM with conventional memory and ADAM with EWC variants.

FIG. 6A shows the overall average accuracy comparison of SGD and ADAM with FN-synapse, ADAM with EWC and Online EWC, SGD, and ADAM with conventional memory. FIG. 6B is a distribution of the usage profile of weights in the output layer and the input layer of the FN-synapse neural network. FIG. 6C presents the overall average accuracy comparison of incremental-domain learning scenarios on the Permuted MNIST dataset using ADAM with EWC, ADAM with FN-Synapse and ADAM with conventional memory. FIG. 6D shows the overall average accuracy comparison of incremental-domain learning scenarios on the Permuted MNIST dataset using ADAGRAD with conventional memory and ADAGRAD with FN-synapse.

With the FN-synapse based approaches, the ability to learn the present task slightly degrades with every new task. This phenomenon results from the FN-synapses becoming more rigid and can be seen from FIG. 6B, which shows the evolution of plasticity of weights in the output and input layer of the network with successive tasks with respect to W_{c}. As mentioned earlier, W_{c} keeps track of the importance of each weight as a function of the number of times it is used. The higher the W_{c} of a particular weight, the less it has been used and therefore, the more plastic it is and sensitive to change. On the other hand, a more rigid and frequently used weight has a lower value of W_{c}. If the output layer is considered from FIG. 6B, it can be observed that with each successive task the W_{c} of the weights of the network collectively reduces, leading to more consolidation and consequently leaving the network with fewer plastic synapses to learn a new task. In comparison, the majority of the weights in the input layer remain relatively more plastic (or less spread out) owing to the redundancies in the network arising from the vanishing gradient problem (see below for more details).

In addition to the split-MNIST benchmark, the performance of FN-synapse based network was compared with EWC for the permuted MNIST benchmark. These incremental-domain learning experiments were carried out by randomly permuting the order of pixels of the images in the MNIST dataset to create new tasks. The overall average accuracy for 10 Monte Carlo simulations when using ADAM as the optimizer with EWC, FN-Synapse and conventional memory are depicted in FIG. 6C. From FIG. 6C it can be seen that despite not being as retentive as EWC in this particular scenario, the network equipped with FN-synapse as the memory element performs better than the network without any memory consolidation mechanism, thereby exhibiting continual learning ability. Furthermore, when compared to a network with traditional memory employing an optimizer like ADAGRAD, which has been shown to be suitable for this learning scenario, the FN-synapse network with ADAGRAD exhibits marginal improvements without any drop in performance with respect to the former as shown in FIG. 6D.

### Weight Update for Differential Synaptic Model

Consider the differential synaptic model described by FIG. 1C where the evolution of two dynamical systems with state variables W⁺ and W⁻ is governed by

$$\frac{{dW}^{+}}{d t} = − J ( {W}^{+} ) + \frac{1}{2} X ( t ) + \frac{1}{2} m ( t ) \qquad ( 6 )$$

$$\frac{{dW}^{-}}{d t} = − J ( {W}^{-} ) − \frac{1}{2} X ( t ) + \frac{1}{2} m ( t ) \qquad ( 7 )$$

where J(·) is an arbitrary function of the state variables, +½ X(t) or −½ X(t) are differential time varying inputs, and M(t) is a common mode modulation input. In this differential architecture, we define the weight parameter W_{d} as W_{d}=½ (W⁺−W⁻) which represents the memory and the common-mode parameter W_{c} as W_{c}=½ (W⁺+W⁻) which represents the usage of the synapse. Applying this definition to (6) and (7), we obtain:

$$\frac{d ( {W}_{c} + {W}_{d} )}{d t} = − J ( {W}_{c} + {W}_{d} ) + \frac{1}{2} X ( t ) + \frac{1}{2} m ( t ) \qquad ( 8 )$$

$$\frac{d ( {W}_{c} − {W}_{d} )}{d t} = − J ( {W}_{c} − {W}_{d} ) − \frac{1}{2} X ( t ) + \frac{1}{2} m ( t ) \qquad ( 9 )$$

Now, adding and subtracting (8) and (9), we get:

$$\frac{d {W}_{c}}{d t} = − ( \frac{J ( {W}_{c} + {W}_{d} ) + J ( {W}_{c} − {W}_{d} )}{2} ) + m ( t ) \qquad ( 10 )$$

$$\frac{d {W}_{d}}{d t} = − ( \frac{J ( {W}_{c} + {W}_{d} ) − J ( {W}_{c} − {W}_{d} )}{2} ) + X ( t ) \qquad ( 11 )$$

Assuming that W_{c}>>W_{d} and applying Taylor series expansion on (10) and (11), we get:

$$\frac{d {W}_{c}}{d t} = - J ( {W}_{c} ) + m ( t ) \qquad ( 12 )$$

$$\frac{d {W}_{d}}{d t} = − {J}^{′} ( {W}_{c} ) {W}_{d} + X ( t ) . \qquad ( 13 )$$

This means that the modulation input impacts the usage of the synapse. Therefore, the plasticity of the synapse can be tuned using m(t) when needed. Now we first look into the trivial case when a constant modulation input is provided, i.e., m(t)=c where c is any arbitrary constant. In this scenario the plasticity of the synapse is solely dependent on the usage of the synapse as m(t) does not change with time. Substituting the derivative of W_{c} from (12), when M(t) is constant, into (13), the rate of change in W_{d} can be formulated as:

$$\frac{d {W}_{d}}{d t} = − [ \frac{{d}^{2} {W}_{c}}{d {t}^{2}} {( \frac{d {W}_{c}}{d t} )}^{− 1} ] {W}_{d} + X ( t ) \qquad ( 14 )$$

Therefore, the change in weight ΔW_{d} is directly proportional to the curvature of usage while being inversely proportional to the rate of usage.

### Optimal Usage Profile

We define the decaying term in (14) as

$$r ( t ) = − [ \frac{{d}^{2} {W}_{c}}{d {t}^{2}} {( \frac{d {W}_{c}}{d t} )}^{- 1} ] \qquad ( 15 )$$

Now, comparing the weight update equation in (14) to the weight update equation for EWC in the balanced input scenario, the decay term has the following dependency with time for avoiding catastrophic forgetting.

$$r ( t ) = O ( \frac{1}{t} ) \qquad ( 16 )$$

Now, the usage of a synapse is always monotonically increasing and since W_{c} represents the usage, it too needs to monotonic. At the same time W_{c} also needs to be bounded, therefore W_{c} has to monotonically decrease with increasing usage while satisfying the relationship in equation (16). It can be shown that equation (16) and (15) can be satisfied by any dynamical system of the form

$${W}_{c} = \frac{1}{f ( log t )} \qquad ( 17 )$$

where f(·)≥0 is any monotonic function. Substituting equation (17) in (15) we obtain the corresponding usage profile as follows

$$r ( t ) = \frac{1}{t} ( 1 + \frac{2 {f}^{′} ( log t )}{log t} − \frac{{f}^{′′} ( log t )}{{f}^{′} ( log t )} ) \qquad ( 18 )$$

where f′(log t) and f″(log t) are derivatives of f(log t) with respect to log t. While several choices of f(·) are possible, the simplest usage profile can be expressed as

$${W}_{c} = \frac{β}{log ( t )} \qquad ( 19 )$$

where β is any arbitrary constant. The corresponding non-linear function in this model is determined by substituting equation (19) in equation (12) to obtain

$$J ( {W}_{c} ) = \frac{1}{β} {W}_{c}^{2} exp ( - \frac{β}{{W}_{c}} ) . \qquad ( 20 )$$

The expression for J(·) in equation (20) bears similarity with the form of FN quantum-tunneling current and FIGS. 1D-1F show the realization of equations (6) and (7) y equations (4) and (5) can be realized using FN tunneling junctions.

### Achieving Optimal Usage Profile on FN-Synapse

For the differential FN tunneling junctions shown in FIG. 1F and its equivalent circuit shown in the FIG. 7 (discussed below), the dynamical systems model is given by

$${C}_{T} \frac{{dW}^{+}}{dt} = - J ( {W}^{+} ) + \frac{{C}_{c}}{2} \frac{{dv}_{in}}{dt} \qquad ( 21 )$$

$${C}_{T} \frac{{dW}^{-}}{dt} = - J ( {W}^{-} ) - \frac{{C}_{c}}{2} \frac{{dv}_{in}}{dt} \qquad ( 22 )$$

where W⁺, W⁻ are the tunneling junction potentials, C_{c} is the input coupling capacitance, x(t) is the input voltage to the coupling capacitance and C_{T}=C_{c}+C_{fg} is the total capacitance comprising of the coupling capacitance and the floating-gate capacitance C_{fg}. J(·) are the FN tunneling currents given by

$$J ( {W}^{+} ) = ( \frac{{k}_{1}}{{k}_{2}} ) {( {W}^{+} )}^{2} exp ( - \frac{{k}_{2}}{{W}^{+}} ) \qquad ( 23 )$$

$$J ( {W}^{-} ) = ( \frac{{k}_{1}}{{k}_{2}} ) {( {W}^{-} )}^{2} exp ( - \frac{{k}_{2}}{{W}^{-}} ) \qquad ( 24 )$$

where k₁ and k₂ are device specific and fabrication specific parameters that remain relatively constant under isothermal conditions. Following the derivations above and the expression in equation (19) leads to a common-mode voltage W_{c} profile as

$${W}_{c} ( t ) = \frac{{k}_{2}}{log ( {k}_{1} t + {k}_{0} )} \qquad ( 25 )$$

where

$${k}_{0} = exp ( \frac{{k}_{2}}{{W}_{c 0}} )$$

and W_{c0} refers to the initial voltage at the floating-gate.

### SFN-Synapse Network SNR Estimation for Random Pattern Experiments

The weight update equation for an FN-synapse using equation (21) and equation (2022 can be expressed as

$${C}_{T} \frac{{dW}_{d}}{dt} = - [ \frac{{d}^{2} {W}_{c}}{{dt}^{2}} {( \frac{{dW}_{c}}{dt} )}^{- 1} ] {W}_{d} + {C}_{c} \frac{{dv}_{in}}{dt} \qquad ( 26 )$$

Floating-gate potential and the input voltage pulses were selected such that the FN-dynamics is only active when there is a memory update. Therefore, the dynamics in equation (26) evolve in a discrete manner with respect to the number of modulations. Assuming C_{T}=C_{c} we formulate a discretized version of the weight update dynamics from equation (26) in accordance with the floating-gate potential profile of the device expressed in equation (25) as follows

$$\frac{Δ {W}_{d} ( n )}{Δ t} = - {k}_{1} ( 1 + \frac{2}{log ( {k}_{1} Δ tn + {k}_{0} )} ) ( \frac{1}{{k}_{1} Δ tn + {k}_{0}} ) \qquad ( 27 )$$

$${W}_{d} ( n - 1 ) + \frac{Δ {v}_{in} ( n )}{Δ t}$$

$${W}_{d} ( n ) = [ 1 - ( 1 + \frac{2}{log ( {k}_{1} Δ tn + {k}_{0} )} ) ( \frac{1}{n + \frac{{k}_{0}}{{k}_{1} Δ t}} ) ] \qquad ( 28 )$$

$${W}_{d} ( n - 1 ) + ( Δ {v}_{in} ( n ) - Δ {v}_{in} ( n - 1 ) )$$

where n represents the number of patterns observed and Δt is the duration of the input pulse. Let us denote the weight decay term as

$$α ( n ) = [ 1 - ( 1 + \frac{2}{log ( {k}_{1} Δ tn + {k}_{0} )} ) ( \frac{1}{n + \frac{{k}_{0}}{{k}_{1} Δ t}} ) ] \qquad ( 29 )$$

Thus, we obtain the weight update equation with respect to number of patterns observed as

$${W}_{d} ( n ) = α ( n ) {W}_{d} ( n - 1 ) + ( Δ {v}_{in} ( n ) - Δ {v}_{in} ( n - 1 ) ) \qquad ( 30 )$$

When we start from an empty network, i.e., W_{d}(0)=0, the memory update can be expressed as a weighted sum over the past input as

$${W}_{d} ( n ) = {\sum }_{i = 1}^{n - 2} \{ ( α ( i + 1 ) - 1 ) ( {\prod }_{j = i + 2}^{n} α ( j ) ) {v}_{in} ( i ) \} + ( α ( n ) - 1 ) {v}_{in} ( n - 1 ) + {v}_{in} ( n ) \qquad ( 31 )$$

For a network comprising of N synapses, each weight in the network is indexed as W_{d}(a, n) where a=1, . . . , N. Similarly, the input applied to the a^{th} synapse after n patterns is Vᵢₙ(a, n). Then, the signal strength for the p^{th} update (where p<n) introduced to the initially empty network tracked after n patterns can be formulated as:

$$S ( n , p ) = \frac{1}{N} 〈 {\sum }_{a = 1}^{N} {W}_{d} ( a , n ) {v}_{in} ( a , p ) 〉 \qquad ( 32 )$$

where angle brackets denote averaging over the ensemble of all of the input patterns seen by the network. If we assume that the input patterns are random binary events of ±1 and are uncorrelated between different synapses and memory patterns then substituting Equation (31) in Equation (32), we obtain

$$S ( n , p ) = ( α ( p + 1 ) - 1 ) {\prod }_{j = p + 2}^{n} α ( j ) \qquad ( 33 )$$

Given that in equation (29), k₀= [symbol] (10^{·}) and k₁=O(10¹⁶) the term

$$( 1 + \frac{2}{ln ( {k}_{1} Δ tn + {k}_{0} )} ) \approx 1 ,$$

the signal power simplifies to:

$${S}^{2} ( n , p ) = \frac{1}{{( n + γ )}^{2}} \qquad ( 34 )$$

where

$$γ = \frac{{k}_{0}}{{k}_{1} Δ t}$$

and depends on the pulse-width Δt and the initial condition k₀. The above equation shows that the signal's strength is a function of the system parameter γ and decays with the number of memory pattern observed. If we assume that the weight W_{d}(n) is uncorrelated from the input vᵢₙ(n) and that the inputs vᵢₙ(1), vᵢₙ(2), . . . vᵢₙ(n) are uncorrelated from each other, then the corresponding noise power is given by the variance of the retrieval signal expressed in Equation (32). This can be estimated as the sum of the power of all signals tracked at n except for the retrieval signal corresponding to the p^{th} update we are tracking and is given by:

$${v}^{2} ( n , p ) = \frac{1}{N} {{\sum }^{n}}_{i = 1 , i \neq p} {S}^{2} ( n , i ) \qquad ( 35 )$$

However, in order to derive a more tractable analytical expression for further analysis we added the retrieval signal as well into the summation which introduces a small error in the estimation (overestimating the noise by the retrieval signal term). This leads us to the following estimation of the noise power:

$${v}^{2} ( n , p ) = \frac{n}{N {( n + γ )}^{2}} \qquad ( 36 )$$

Based on the value of n in comparison to γ, we obtain two trends for the noise profile. When γ>>n,

$$v ( n , p ) = \frac{1}{\sqrt{N}} ( \frac{\sqrt{n}}{γ} ) \qquad ( 37 )$$

which implies that noise increases with increase in updates initially. On the other hand, when γ<<n,

$$v ( n , p ) = \frac{\sqrt{n}}{\sqrt{N} n} = \frac{1}{\sqrt{N}} ( \frac{1}{\sqrt{n}} ) \qquad ( 38 )$$

which implies that noise falls with increase in updates in the later stages. The signal-to-noise ratio (SNR) of a network of size N can then be obtained as:

$$S N R ( n , p ) = \sqrt{\frac{{S}^{2} ( n , p )}{{v}^{2} ( n , p )}} = \sqrt{\frac{N}{n}} \qquad ( 39 )$$

FN-Synapse with Tunable Consolidation Characteristics

In the previous sections, we derived the analytical expressions for the memory retrieval signal, the noise associated with it, and the corresponding SNR for the case when the modulation input m(t) was kept constant. This led to a synaptic memory consolidation which is similar to that of EWC. However, blackout catastrophic forgetting occurs in networks with such memory consolidation due to the absence of a balanced pattern retention and forgetting mechanism. The forgetting mechanism is naturally present in a steady state model such as the cascade model which do not suffer from memory “blackouts”. Since the increase in retention is equivalent to an increase in rigidity and forgetting is tantamount to a decrease in rigidity, it is necessary to adjust the plasticity/rigidity of the synapse accordingly. From FIGS. 2A and 2B, we notice that without external modulation W_{c} decreases monotonically with each new updates which correspondingly makes the synapse only rigid. Therefore, to balance the same, the idea is to keep W_{c} as steady as possible to keep the synapse plastic as long as possible by applying a modulation profile m(t) that recovers/restores W_{c} after every synaptic update. This results in m(t) of the form

$$m ( t ) = m ( i ) δ ( t - iT ) \qquad ( 40 )$$

where δ(t) is the Dirac-delta, m(i) is the magnitude of the modulation increment, and T is the time between each modulation increment. This increment is determined by the rate of the differential update to the FN-synapse. Integrating this form of m(t) into Equation (12) leads to

$$\frac{{dW}_{c}}{dt} = - J ( {W}_{c} ) + m ( i ) δ ( t - iT ) \qquad ( 41 )$$

which implies a tunable plasticity profile for the FN-synapse. An analytical solution to the differential equation (43) is difficult and hence we resort to a recursive solution. Due to the nature of the m(t), it can be seen that the initial condition of the variable We changes at increments of T, whereas between two modulation increments We evolves naturally according to Equation (25). Thus, the dynamics of W_{c} in the presence of the modulation increments can be described as

$${W}_{c} ( t ) = \{ \begin{matrix}{W}_{c 0} ; & t = 0 \\ {W}_{c} ( t ) + {V}_{mod} ( t ) ; & t = iT \\ \frac{{k}_{2}}{log ( {k}_{1} ( t - iT ) + exp ( \frac{{k}_{2}}{{W}_{c} ( iT )} ) )} ; & iT < t < ( i + 1 ) T\end{matrix} \qquad ( 42 )$$

where V_{mod}(t) is an external voltage signal applied to the FN-synapse as shown in FIG. 7 and is given by:

$${V}_{mod} ( t ) = {\sum }_{i = 1}^{∞} m ( i ) δ ( t - iT ) \qquad ( 43 )$$

In this case the change in plasticity of the synapse is determined by the step-size of the staircase voltage function V_{mod}(t). Note that the weight update equation in (13) is still valid since m(t) is kept constant during differential input.

Although an analytic expression for the SNR is no longer tractable in this iterative form, the ability of the modulation term to regulate the plasticity and induce a more graceful form of forgetting is shown in the corresponding no. of patterns retained plot in FIG. 5A and the SNR plot FIG. 5B for various modulation input profiles.

### Programming and Initialization of FN-Synapses

The potential corresponding to the tunneling nodes W⁺ and W⁻ can be accessed through a capacitively coupled node, as shown in FIG. 7. This configuration minimizes readout disturbances and the capacitive coupling also acts as a voltage divider so that the readout voltage is within the input dynamic range of the buffer. The configuration also prevents hot-electron injection of charge into the floating gate during readout operation. The tunneling node potential was initialized at a specific region where FN-tunneling only occurs while there is a voltage pulse at the input node and the rest of the time it behaves as a non-volatile memory. This was achieved by first measuring the readout voltage every 1 second for a period of 5 min to ensure that the floating gate was not discharging naturally. During this period the noise floor of the readout voltage was measured to be ≈100 μV. At this stage, a voltage pulse of magnitude 1 V and duration 1 ms was applied at the input node and the change in readout voltage was measured. If the change was within the noise floor of the readout voltage, the potential of the tunneling nodes were increased by pumping electrons out of the floating gate using the program tunneling pin. This process involves gradually increasing the voltage at the program tunneling pin to 20.5 V (either from external source or from on-chip charge pump). The voltage at the program tunneling pin was held for a period of 30 s, after which it was set to 0 V. The process was repeated until substantial change in the readout voltage was observed (≈300 μV) after providing an input pulse. The readout voltage in this region was around 1.8 V.

### Hardware and Software for Random Pattern Updates

A prototype was fabricated that contained 128 differential FN tunneling junctions, which corresponds to 64 FN-synapses. However, due to the peripheral circuitry only one tunneling node could be accessed at a time for readout and modification. Because the memory pattern is completely random, each synapse can be modified independently without affecting the outcome. Therefore, two tunneling nodes were initialized following the method described above. Input pulses of magnitude 4V and duration 100 ms was applied to both the tunneling nodes. The change in the readout voltages were measured, and the region where the update sizes of both the tunneling node would be equal was chosen as the initial zero memory point for the rest of the experiment. The nodes were then modified with a series of 100 potentiation and depression pulses of magnitude 4.5 v and duration 250 ms and the corresponding weights were recorded. This procedure represented the 100 updates of a single synapse. The tunneling nodes were then reinitialized to the zero memory point and the procedure was repeated with different random series of input pulses representing the modification of other 99 synapse in the network. The first input pulses of each series of modification forms the tracked memory pattern. To modify the value of γ the FN-synapses were initialized at a higher tunneling node potential.

The behavioral model of the FN-synapse was generated by extracting the device parameters k₁ and k₂ from the hardware prototype. The extracted parameters have been shown to capture the hardware response with an accuracy greater than 99.5%. These extracted parameters were fed into a dynamical system which follows the usage profile described herein with reference to hardware implementation and follow the weight update rule described herein with respect to SNR estimation to reliably imitate the behavior of the FN-synapse. The behavioral model network was started with exactly the same initial condition as hardware synapses and subjected to the exact memory patterns used for the hardware experiment for the same number of iterations. The simulation was also extended to 1000 iterations and the corresponding responses are included in FIG. 4F.

### Probabilistic FN-Synapse Model

Adaption of FN-synapse occurs by tunneling of electrons through a triangular FN quantum-tunneling barrier. The tunneling current density is dependent on the barrier profile which in turn is a function of the floating-gate potential. When W⁺, W⁻ is around 7 V the synaptic update ΔW_{d} due to an external pulse can be determined by the continuous and deterministic form of the FN-synapse model (as described in the previous sections). Since the number of electrons tunneling across the barrier is relatively large (>>1), the method is adequate for determining ΔW_{d}. However, once W⁺, W⁻ is around 6 V, each updates occurs due to the transport of a few electrons tunneling across the barrier and in the limit by a single electron tunneling across the barrier at a time. In this regime, the continuous behavioral model is no longer valid. Therefore, the behavioral model of the FN-synapse has to switch to a probabilistic model. In this mode of operation, we can assume that each electron tunneling event follows a Poisson process where the number of electrons e⁺(n), e⁻(n) tunneling across the two junctions during the n^{th} input pulse is estimated by sampling from a Poisson distribution with rate parameters λ⁺, λ⁻ given by

$${λ}^{+} ( n ) = \frac{AJ ( {W}^{+} ( n ) )}{q} \qquad ( 44 )$$

$${λ}^{-} ( n ) = \frac{AJ ( {W}^{-} ( n ) )}{q} . \qquad ( 45 )$$

q is the charge of an electron, A is the cross-sectional area of the tunneling junction. Using the sampled values of e⁺(n), e⁻(n), the corresponding discrete-time stochastic equation governing the dynamics of the tunneling node potentials W⁺(n), W⁻(n) is given by

$${W}^{+} ( n ) = {W}^{+} ( n - 1 ) - \frac{{qe}^{+} ( n )}{{C}_{T}} \qquad ( 46 )$$

$${W}^{-} ( n ) = {W}^{-} ( n - 1 ) - \frac{{qe}^{-} ( n )}{{C}_{T}} \qquad ( 47 )$$

where CT is the equivalent capacitance of the tunneling node.

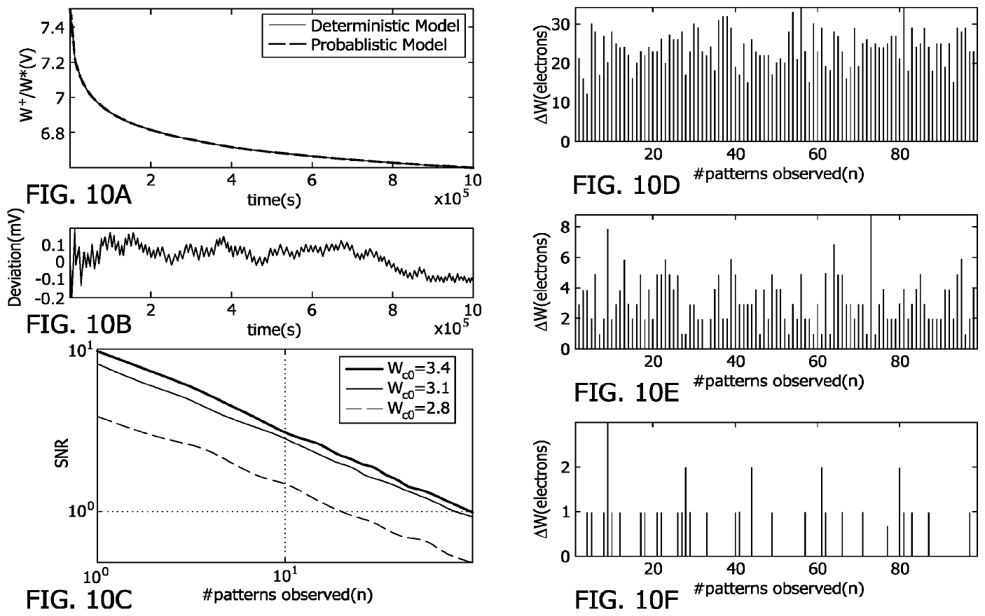

The validity/accuracy of the probabilistic model has been verified against the continuous-time deterministic model in high tunneling rate regimes. FIG. 10A shows that the output of the probabilistic model matches closely to the deterministic model and the deviation which arises due to the random nature of the probabilistic updates (shown in FIG. 10B) is within 200 μV. Using the probabilistic model, the memory retention and network capacity experiments (as discussed herein) were performed by initializing the tunneling nodes at a low potential. In this regime, each updates to the FN synapse results from tunneling of a few electrons. FIGS. 10C and 10D show that even when each update sizes are on the order of tens of electrons, the network capacity and memory retention time remains unaffected. However, as the synaptic voltage is modified by less than ten electrons per update (shown in FIG. 10E), the SNR curve starts to shift downwards and the network capacity along with memory retention time decreases. The tunneling node potential can be pushed further down to a region where the synapses might not even register modifications at times and other times update sizes drop down to single electron per modification (see FIG. 10F). In this regime, the SNR curve shifts down further, the SNR decay still obeys the power-law curve.

### Neural Network Implementation Using FN-Synapses

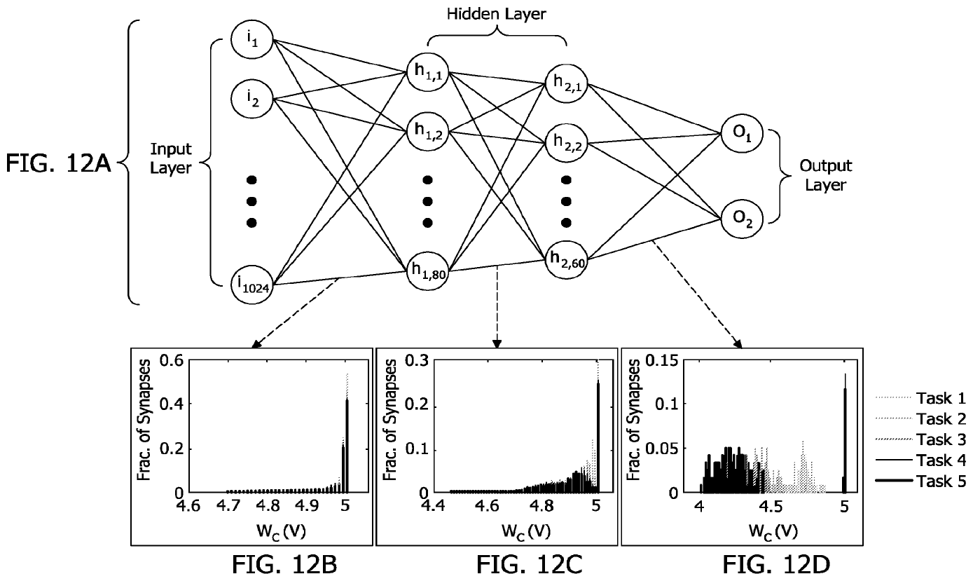

The MNIST dataset was split into 60,000 training images and 10,000 test images which yielded about 6000 training images and 1000 test images per digit. Each image, originally of 28×28 pixels, was converted to 32×32 pixels through zero-padding. This was followed by standard normalization to zero mean with unit variance. The code for implementing the non-FN-synapse approaches such as EWC and online EWC were obtained from a repository. To enforce an equitable comparison, the same neural network architecture (as shown in FIG. 12), in the form a multi-layered perceptron (MLP) with an input layer of 1024 nodes, two hidden layers of 400 nodes each (paired with the ReLU activation function) and a softmax output layer of 2 nodes, has been utilized by every method mentioned in this disclosure. Based on the optimizer in use, a learning rate of 0.001 was chosen for both SGD and ADAM (with additional parameters β₁, β₂ and ϵ set to 0.9, 0.999 and 10⁻⁸ respectively for the latter). Each model was trained with a mini-batch size of 128 for a period of 4 epochs.

Similar to the continual learning experiments conducted on split-MNIST, benchmark incremental-domain learning experiments were also carried out by randomly permuting the order of pixels of the images in the MNIST dataset, which is referred as the Permuted-MNIST. The architecture of the neural network employed is similar to the one for the split-MNIST with the exception of being equipped with 1,000 neurons in each of the two hidden layers instead of 400 and with 10 neurons in the output layer instead of 2. This essentially means that at each task, the network learns a new set of permutations of the 10 digits. The network was trained on 10 such tasks for 3 epochs using a learning rate of 0.0001 for ADAM and 0.001 for ADAGRAD.

Corresponding to every weight/bias in the MLP, an instance of the FN-synapse model was created and initialized to a tunneling region according to the initial W_{c} value. As demonstrated by the measured results described above, ΔW_{d} can be modulated linearly and precisely by changing the pulse-width of the potentiation/depression pulses. Therefore, each weight update (calculated according to the optimizer in use) is mapped as an input pulse of proportional duration for the FN synapse instance. Then, every instance of the FN-synapse model is updated according to Eq. (25) and the W_{d} thus obtained in voltage is scaled back to a unit-less value and within the required range of the network.

### Equivalent Circuit Model of FN-Synapse

The equivalent circuit model of a single FN-synapse is shown in FIG. 6. The synaptic weight W_{d} is stored as a difference between the voltages (W⁺ and W⁻) on the floating-gates. The FN tunneling current is modeled using voltage dependent current sources J(W⁺), J(W⁻) that discharge the floating-gate capacitances C_{fg}. Both W_{d} and the common-mode voltage W_{c} are estimated by measuring W⁺ and W⁻ using a capacitive divider formed by C₁ and C₂ and respective source-followers A. This configuration has been previously demonstrated to avoid read-disturbances when measuring the floating-gate voltages. External input vᵢₙ is differentially coupled to the FN-synapse through the capacitances C_{c} and C_{mod} is used to couple the signal

$$m ( t ) = \frac{{dv}_{mod} ( t )}{dt}$$

common to all synapses. m(t) is used to adjust the plasticity of the entire synaptic array. The initial charge on the floating-gates are programmed using a combination of FN quantum-tunneling and hot-electron injections.

### Behavioral Model of the FN-Synapse

The fabricated prototype of the FN-synapse array comprises of 64 FN-synaptic elements. Thus, for large-scale memory consolidation experiments and for large-scale continual learning experiments, a behavioral model that can accurately capture the response of each FN-synapse in the array is needed. Equation (25) can accurately (accuracy greater than 99%) model the dynamic response of a single FN tunneling junction and a corresponding integrator. For this work we instantiated two tunneling junctions corresponding to the floating-gates W⁺ and W⁻ and the model parameters k₀, k₁ and k₂ were estimated using measured results. A non-linear regression was specifically used to estimate k₁ and k₂, whereas k₀ was determined from the voltage to which each of the floating-gates were initialized. To validate the behavioral model of the FN-synapse, a set of experiments was carried out and the outputs were compared against the analytical results shown in equations (33) and (36)-(38). Note that these analytical expressions were derived for a constant modulation input, therefore V_{mod}(t) was kept constant at 0V in all the simulated experiments FIGS. 8 and 9 summarize the results obtained from the behavioral model.

The weight evolution of an FN-synapse using the fabricated prototype for a series of potentiation/depression pulses was measured. The same input was provided to the software model and the weight evolution was simulated. FIG. 8A shows that the stored weight of the software model accurately matches with that of the hardware FN-synapse with a small deviation as shown in FIG. 8B. This verifies that both hardware FN-synapse and software model behave similarly when subjected to same stimuli. Next, a Monte-Carlo simulation was run where a network of N=10000 FN-synapses was updated with random binary pattern. Each tunneling junction of FN-synapses were initialized at W_{c0}=4.5 v. The updates were provided as a differential input voltage pulses of magnitude 4V and duration Δt=100 mS to each synapses. The experiment was repeated for 1000 Monte-Carlo simulations. FIGS. 9A-9L show comparisons between the behavioral model and the analytical model of the FN-synapse FIGS. 9A, 9B, and 9C show the SNR, memory retrieval signal S(n) and the noise v(n) respectively obtained from the software model of FN-synapse network. The effect on the SNR, signal, and noise of the software model when the pulse-width of the input pulse is varied is shown in FIGS. 9D-9F, and the effect on the SNR, signal, and noise of the software model when the magnitude of the input pulse is varied is shown in FIGS. 9G-9I. FIGS. 9J-9L show the impact of change in network size on SNR, signal, and noise. In FIG. 9A, the SNR from the software model matches accurately with the analytical expression. Both S(n) and v(n) described in equation (4) have two different regimes depending on the value of γ. When n<<γ, S(n) is approximately constant and v(n) increases at a rate of \sqrt{n}. On the other hand, when n>>γ, S(n) and v(n) falls off at a rate of 1/n and 1/\sqrt{n} respectively. FIGS. 9B and 9C show that the response from the software model follows these trends and captures both the regimes accurately. The effect on the SNR, signal, and noise of the software model when the pulse-width of the input pulse is varied is shown in FIGS. 9D-9F, and the effect on the SNR, signal, and noise of the software model when the magnitude of the input pulse is varied is shown in FIGS. 9D-9F. FIGS. 9J-9L show the impact of change in network size on SNR, signal, and noise.

Whether the FN-synapse network shows similar trends as the analytic expression in response to changing the value of γ in equation (3) was verified. Note that the parameter γ is defined as

$$γ = \frac{{k}_{0}}{{k}_{1} Δ t} \qquad ( 48 )$$

where

$${k}_{0} = exp ( \frac{{k}_{2}}{{W}_{c 0}} ) .$$

Therefore, γ for the same set of FN-synapses increases when Δt or Wc0 decreases and vice versa. According to equation (4), the value of n at which the regimes in these responses changes also shifts. Moreover, the initial values for both S(n) and v(n) depends on the value of γ while SNR is agnostic to changes in γ. FIGS. 9D-9I show the FN-synapse responses in relation to changing the pulse width and the initialization condition for a network size of N=1000. From the figures we can observe that the software model is in very good agreement with the analytic expressions. Finally, the behavioral model was verified in relation to change in the size N of the FN-synapse network. From the analytic expressions in equation (4), SNR & \sqrt{N} and

$$v ( n ) ∝ \frac{1}{\sqrt{N}}$$

while S(n) remains constant with respect to N. FIGS. 9J-9L show that the FN-synapse network exhibits these attributes accurately. Note that the regime switching point in S(n) and v(n) remains constant, since γ does not depend on the size of the network.

### Probabilistic FN-Synapse Model

The update process for FN-synapse involves tunneling of electron through a triangular FN quantum-tunneling barrier. The tunneling current density is dependent on the barrier profile which in turn is a function of the floating gate potential. When W⁺, W⁻ is around 7 V the synaptic update ΔW_{d} due to an external pulse can be found out using the continuous and deterministic form of the FN-synapse model (as described above). Since the number of electrons tunneling across the barrier is relatively large, the method is adequate for determining ΔW_{d}. However, once W⁺, W⁻ is around 6 V, each updates occurs due to the transport of a few electrons tunneling across the barrier and in the limit only one electron tunneling across. In this regime, the continuous behavioral model is no longer valid. Therefore, in this region the FN-synapse switches to a probabilistic model. We can assume that each electron tunneling event follows a Poisson process where the number of electrons e⁺(n), e⁻(n) tunneling across the two junctions during the n^{th} input pulse is estimated by sampling from a Poisson distribution with rate parameters λ⁺, λ⁻ given by

$${λ}^{+} ( n ) = \frac{AJ ( {W}^{+} ( n ) )}{q} \qquad ( 49 )$$

$${λ}^{-} ( n ) = \frac{AJ ( {W}^{-} ( n ) )}{q} . \qquad ( 50 )$$

q is the charge of an electron, A is the cross-sectional area of the tunneling junction. Using the sampled values of e⁺(n), e⁻(n), the corresponding discrete-time stochastic equation governing the dynamics of the tunneling node potentials W⁺(n), W⁻(n) is given by

$${W}^{+} ( n ) = {W}^{+} ( n - 1 ) - \frac{{qe}^{+} ( n )}{{C}_{T}} \qquad ( 51 )$$

$${W}^{-} ( n ) = {W}^{-} ( n - 1 ) - \frac{{qe}^{-} ( n )}{{C}_{T}} \qquad ( 52 )$$

where C^{T} is the equivalent capacitance of the tunneling node.

The validity/accuracy of the probabilistic model has been verified against the continuous-time deterministic model in high tunneling rate regimes. FIG. 10A compares the output of the probabilistic FN-synapse model and the deterministic behavioral model. FIG. 10B shows the corresponding deviation. FIG. 10C graphs the SNR of the network for different tunneling regions for W_{c}0=3.4V, 3.1V and 2.8V. FIGS. 10D, 10E, and 10F graph the corresponding update size in terms of numbers of electrons per update for the three conditions in FIG. 10C. FIG. 10A shows that the output of the probabilistic model matches closely to the deterministic model and the deviation which arises due to the random nature of the probabilistic updates (shown in FIG. 10B) is within 200 μv. Using the probabilistic model, memory retention and network capacity experiments (as discussed were performed) by initializing the tunneling nodes at a low potential. In this regime, each updates to the FN synapse results from tunneling of a few electrons. FIGS. 10C and 10D show that even when each update sizes are on the order of tens of electrons, the network capacity and memory retention time remains unaffected. However, as the update sizes go below ten electrons per modification (shown in FIG. 10E), the SNR curve starts to shift downwards and the network capacity along with memory retention time decreases. The tunneling node potential can be pushed further down to a region where the synapses might not even register modifications at times and other times update sizes drop down to single electron per modification (see FIG. 10F). In this regime, the SNR curve shifts down further, the SNR decay still obeys the power-law curve.

### Plasticity and Consolidation

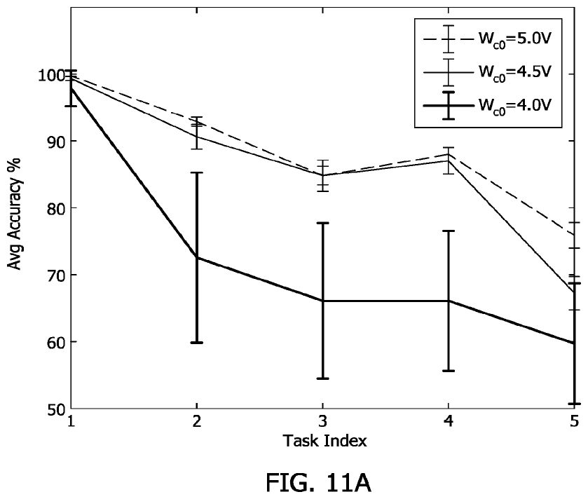

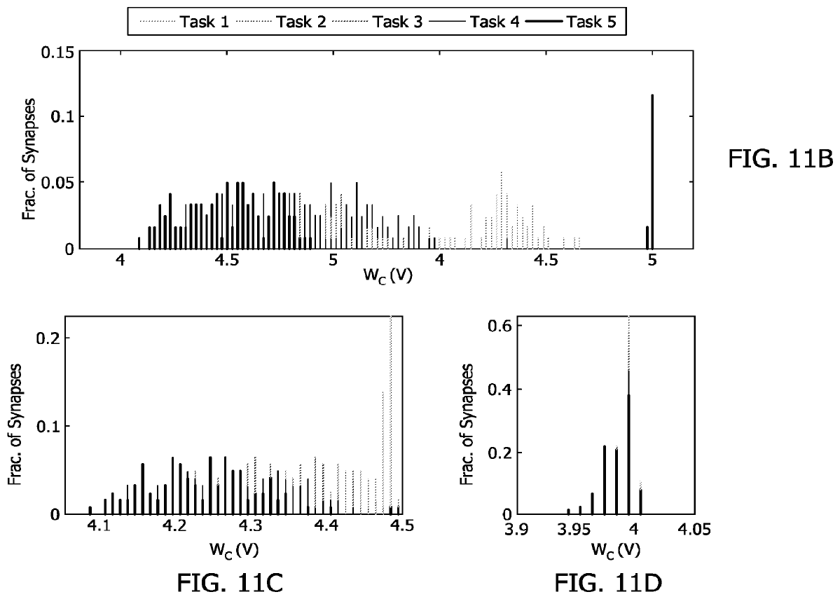

The ability of a network to learn new tasks is contingent on the availability of adequate range of plasticity of the synapses so that the weights learned from previous tasks can adapt sufficiently to reflect the requirements for the new tasks. Traditional volatile memories have practically infinite range of plasticity and can therefore change the weights stored to any extent that is required. However, this feature might not be beneficial for continual learning where the network needs to learn new tasks without forgetting the previous ones. This rigidity-plasticity dilemma is a core underpinning of memory consolidation where more frequently used synapses become more rigid in comparison to the less frequently used synapses. Thus, a balance between the range of plasticity required to learn successive tasks and the consolidation of the weights learned in the process is key to continual learning. In the case of FN-synapse based neural networks, the range of plasticity is determined by the initial tunneling region of the device. FIGS. 11A-11D show the effect of initial plasticity (Wc₀) of and FN-synapse on the overall average accuracy of the split-MNIST incremental domain learning tasks as a result of the degree of change in plasticity of their corresponding weights for Wc₀=5.0V, Wc₀=4.5V and Wc₀=4.0V. A high tunneling region, denoted by a larger value of Wc₀, ensures that the synapses are plastic enough to learn several successive tasks and slowly become rigid over time. This is seen in the case of Wc₀=5V and Wc₀=4.5V, which exhibit significantly better overall average accuracy over five tasks as shown in FIG. 11A as the weights stored in their synapses (shown in FIGS. 11B and 11C respectively) slowly spread from a highly plastic to a rigid region over the course of the five tasks. In contrast, a relatively low initial tunneling region, such as in the case of Wc₀=4V, does not learn new tasks as well as the previous couple of cases as shown in FIG. 11A because in this case the weights stored in the synapse are already relatively rigid at the point of initiation and barely undergo any change as illustrated in FIG. 11D. Therefore, by choosing the initial plasticity level appropriately we can achieve an optimal balance between the range of plasticity and consolidation suitable for continual learning. Choosing an appropriate temporal profile of m(t) can be used to re-adjust the plasticity of the synapses after each update, it does not however change the range of plasticity afforded to the network since that is determined by the initial Wc₀.

### Neural Network Architecture

FIG. 12A is an example architecture of a neural network as used in the disclosure. The evolution of corresponding weights between layer 1 and 2 over five successive tasks is shown in FIG. 12B, evolution of corresponding weights between layer 2 and 3 over five successive tasks is shown in FIG. 12C, and evolution of corresponding weights between layer 3 and 4 over five successive tasks is shown in FIG. 12D.

The architecture of an example 4-layer fully-connected MLP is shown in FIG. 12A. The MLP includes an input layer of 1024 neurons corresponding to images of 32×32 pixels, two hidden layers of 80 and 60 neurons each, and an output layer of 2 neurons that differentiates between (0,1) in t₁, (2,3) in t₂, (4,5) in t₃, (6,7) in t₄ and (8,9) in t₅. The MLP network may be implemented with FN-synapses according to this disclosure. For simulations discussed herein, the MLP network was constructed in MATLAB and trained with SGD and ADAM with learning rate of 0.001 for 4 epochs with a minibatch size of 128. For comparisons with EWC and Online EWC, the network was replicated in python and trained with exactly the same parameters.

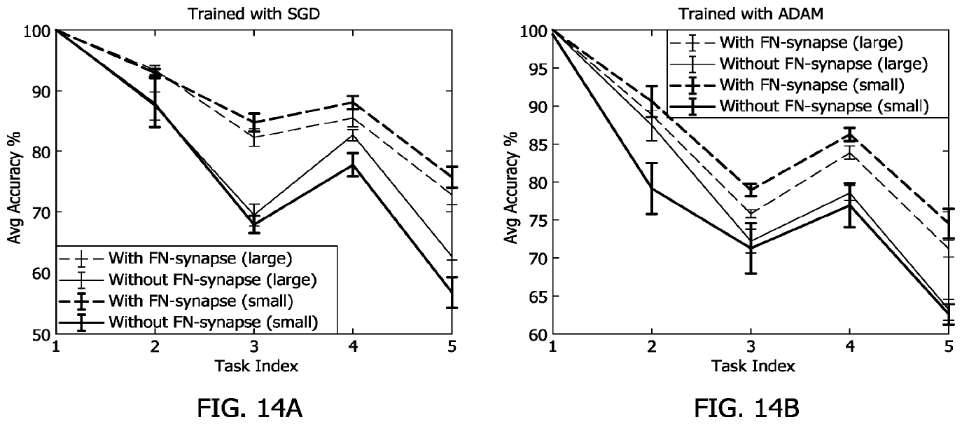

The evolution of the plasticity/usage of weights of the different layers of the FN-synapse based neural network are shown in FIGS. 12B-12D. Given the relatively large number of weights between layer 1-2 and layer 2-3, the amount of change in plasticity that they undergo (as shown in FIGS. 12B and 12C respectively) is much less in comparison with those between layer 3-4 (as shown in FIG. 12D) as the presence of fewer weights ensures that they are modified considerably frequently due to lack of any redundancy. FIGS. 6 and 14 depict the advantages of the FN-synapse based neural networks using either SGD or ADAM as the optimizer when employed within the aforementioned architecture. FIG. 14 shows the effect of network size on overall average accuracy when the network in FIG. 12A was trained with SGD (FIG. 14A) and ADAM (FIG. 134). In addition, if the size of the neural network is increased by increasing the number of neurons in the hidden layers from 80/60 in layer 2/3 to 400/400, it can be observed from FIGS. 14A and 14B that the average overall accuracy of the FN-synapse based network still outperforms the ones without it as the memory element. Interestingly, the accuracy of the larger network with FN-synapse is slightly lower than that of the smaller network with FN-synapse for task 3 and beyond. This dip is actually an indication of higher plasticity, and therefore slower consolidation, of the larger network due to presence of many more synapses which are still highly plastic after several tasks, which makes FN-synapse based large neural networks equipped with the capability of learning more complicated tasks than split-MNIST and yet exhibit far better consolidation than conventional memory.

### Effects of Mismatch

The FN-synapse comprises of two differential FN tunneling junctions and the operation of the synapse assumes that the junctions are well matched. This may allow the weights stored in the synapse to remain equally plastic/rigid, when increasing or decreasing the magnitude of the weight. The tunneling rates of the two junctions corresponding to W⁺ and W⁻ should be synchronized with each other. Two such FN-dynamical systems can be synchronized to a very high degree of accuracy even in the presence of temperature variations or device mismatch.

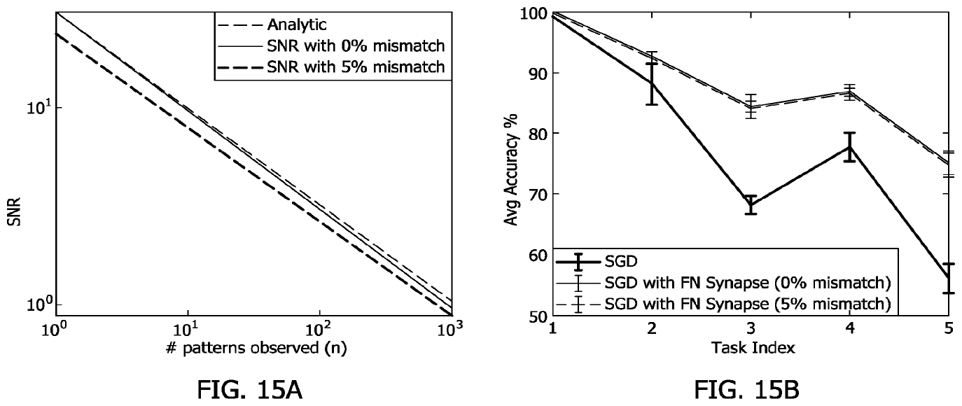

On the other hand, mismatch in device characteristics across one or more FN synapses, specifically the parameters k₁ and k₂, must be taken into consideration. This is because a neural network could include billions of synapses and mismatch in synaptic behavior could pose a problem. FIGS. 15A and 15B present the effect of mismatch in device characteristics across FN synapses on memory retention and learning ability on the split-MNIST based incremental domain learning tasks. FIG. 15A shows the effect of a 5% mismatch in device characteristics across synapses on the SNR of an FN-synapse network comprising of 10,000 synapses. For this example, the network was subjected to 10,000 randomized balanced updates, similar to the previous consolidation experiments. It can be observed that the network with mismatch shows a small degradation in SNR or memory retention compared to the one without any mismatch. However, the SNR still follows the power-law curve. On the contrary a mismatch of 5% does not lead to any deterioration whatsoever of the average overall accuracy of the network when trained with SGD over the split-MNIST dataset with the incremental domain learning tasks as depicted in FIG. 15B. This shows the robustness of the FN-synapse based network and the ability of learning to compensate for device mismatch.

### Detailed Derivations

### Weight Update for Differential Synaptic Model

The state equations of two dynamical systems (corresponding to state variables W⁺ and W⁻ with J(·) defining their rate of change), when subjected to differential input ±X(t) and common-mode modulation input m(t) is given by:

$$\frac{{dW}^{+}}{dt} = - J ( {W}^{+} ) + \frac{1}{2} X ( t ) + \frac{1}{2} m ( t ) \qquad ( 53 )$$

$$\frac{{dW}^{-}}{dt} = - J ( {W}^{-} ) - \frac{1}{2} X ( t ) + \frac{1}{2} m ( t ) \qquad ( 54 )$$

### Since,

$${W}_{d} = \frac{{W}^{+} - {W}^{-}}{2} and {W}_{c} = \frac{{W}^{+} + {W}^{-}}{2} ,$$

equations (53) and (54) can be written as:

$$\frac{d ( {W}_{c} + {W}_{d} )}{dt} = - J ( {W}_{c} + {W}_{d} ) + \frac{1}{2} X ( t ) + \frac{1}{2} m ( t ) \qquad ( 55 )$$

$$\frac{d ( {W}_{c} - {W}_{d} )}{dt} = - J ( {W}_{c} - {W}_{d} ) - \frac{1}{2} X ( t ) + \frac{1}{2} m ( t ) \qquad ( 56 )$$

Then, by adding and subtracting (55) and (56), the following is obtained:

$$\frac{{dW}_{c}}{dt} = - ( \frac{J ( {W}_{c} + {W}_{d} ) + J ( {W}_{c} - {W}_{d} )}{2} ) + m ( t ) \qquad ( 57 )$$

$$\frac{{dW}_{d}}{dt} = - ( \frac{J ( {W}_{c} + {W}_{d} ) - J ( {W}_{c} - {W}_{d} )}{2} ) + X ( t ) \qquad ( 58 )$$

Upon applying Taylor series expansion on (57) and (58), with the assumption that W_{c}>>W_{d}, we get:

$$\frac{{dW}_{c}}{dt} = - J ( {W}_{c} ) + m ( t ) \qquad ( 59 )$$

$$\frac{{dW}_{d}}{dt} = - {J}^{′} ( {W}_{c} ) {W}_{d} + X ( t ) \qquad ( 60 )$$

Therefore, to obtain an expression of weight update

$$( \frac{{dW}_{d}}{dt} )$$

with respect to the common-mode usage (W_{c}), we need to obtain an expression for J′(W_{c}). Thus, by differentiating (59) with respect to t, we obtain:

$$\frac{{d}^{2} {W}_{c}}{{dt}^{2}} = - {J}^{′} ( {W}_{c} ) \frac{{dW}_{c}}{dt} + {m}^{′} ( t ) \qquad ( 61 )$$

$${J}^{′} ( {W}_{c} ) = - \frac{( \frac{{d}^{2} {W}_{r}}{{dt}^{2}} - {m}^{′} ( t ) )}{\frac{{dW}_{c}}{dt}} \qquad ( 62 )$$

Inserting (62) into (60), we get:

$$\frac{{dW}_{d}}{dt} = - [ \frac{\frac{{d}^{2} {W}_{c}}{{dt}^{2}} - {m}^{′} ( t )}{\frac{{dW}_{c}}{dt}} ] {W}_{d} + X ( t ) \qquad ( 63 )$$

Now, for the trivial case where m(t)=c, where c is an arbitrary constant, m′(t)=0 and thus (63) becomes:

$$\frac{{dW}_{d}}{dt} = - [ \frac{{d}^{2} {W}_{c}}{{dt}^{2}} {( \frac{{dW}_{c}}{dt} )}^{- 1} ] {W}_{d} + X ( t ) \qquad ( 64 )$$

### Optimal Usage Profile

The decay rate (r(t)) obtained from the weight update rule in equation (64) is given by:

$$r ( t ) = - [ \frac{{d}^{2} {W}_{c}}{{dt}^{2}} {( \frac{{dW}_{c}}{dt} )}^{- 1} ] \qquad ( 65 )$$

To avoid catastrophic forgetting, the decay rate associated with the EWC model's weight update rule, for the case of balanced inputs, is

$$r ( t ) = O ( \frac{1}{t} ) .$$

Therefore, by choosing

$${W}_{c} = \frac{1}{f ( log t )}$$

where f(·)≥0 is a monotonic function we obtain

$$r ( t ) = \frac{1}{t} ( 1 + \frac{2 {f}^{′} ( log t )}{log t} - \frac{{f}^{″} ( log t )}{{f}^{′} ( log t )} ) \qquad ( 66 )$$

which is of the order

$$O ( \frac{1}{t} ) .$$

The simplest form of f(·) such that W_{c} satisfies both monotonicity and the order of decay, is given by:

$${W}_{c} = \frac{β}{log ( t )} \qquad ( 67 )$$

where β is an arbitrary constant. Consequently, to obtain the non-linear function J(·) which enforces the above constraint, we substitute (67) into (59) to get

$$\frac{d ( \frac{β}{log ( t )} )}{dt} = - J ( {W}_{c} ) + m ( t ) \qquad ( 68 )$$

$$\frac{- β}{{t ( log ( t ) )}^{2}} = - J ( {W}_{c} ) + m ( t ) \qquad ( 69 )$$

For the case of m(t)=0, equation (69) becomes

$$J ( {W}_{c} ) = \frac{β}{{t ( log ( t ) )}^{2}} \qquad ( 70 )$$

Now, from (67), we can obtain an expression for log(t) as

$$log ( t ) = \frac{β}{{W}_{c}} \qquad ( 71 )$$

And an expression for t as follows:

$$exp ( log ( t ) ) = exp ( \frac{β}{{W}_{c}} ) \qquad ( 72 )$$

$$t = exp ( \frac{β}{{W}_{c}} ) \qquad ( 73 )$$

Then, by substituting (71) and (73) in (70), we obtain:

$$J ( {W}_{c} ) = \frac{1}{β} {W}_{c}^{2} exp ( - \frac{β}{{W}_{c}} ) \qquad ( 74 )$$

Signal-to-noise Ratio Estimation for Random Pattern Experiment

The weight update equation for an FN-synapse (similar to equation (64)) is given by:

$${C}_{T} \frac{{dW}_{d}}{dt} = - [ \frac{{d}^{2} {W}_{c}}{{dt}^{2}} {( \frac{{dW}_{c}}{dt} )}^{- 1} ] {W}_{d} + {C}_{c} \frac{{dv}_{in}}{dt} \qquad ( 75 )$$

where C_{T}=f(Cᵢ, C₂, C_{fg}) is the cumulative capacitance and C_{c} is the coupling capacitance of the FN-synapse equivalent circuit as shown in FIG. 7. Since, the physics of FN-tunneling leads to a common-mode voltage W_{c} profile such that

$${W}_{c} ( t ) = \frac{{k}_{2}}{log ( {k}_{1} t + {k}_{n} )} \qquad ( 76 )$$

where

$${k}_{0} = exp ( \frac{{k}_{2}}{{W}_{co}} )$$

and W_{co} refers to the initial voltage at the floating-gate, by substituting (76) in (75), we get:

$${C}_{T} \frac{{dW}_{d}}{dt} = - [ \frac{( \frac{{k}_{1}^{2} {k}_{2}}{{( {k}_{1} t + {k}_{0} )}^{2} {log}^{2} ( {k}_{1} t + {k}_{0} )} )}{( \frac{{k}_{1} {k}_{2}}{( {k}_{1} t + {k}_{0} ) {log}^{2} ( {k}_{1} t + {k}_{0} )} )} ( 1 + \frac{2}{log ( {k}_{1} t + {k}_{0} )} ) ] {W}_{d} + {C}_{c} \frac{{dv}_{in}}{dt} \qquad ( 77 )$$

$${C}_{T} \frac{{dW}_{d}}{dt} = - [ ( \frac{{k}_{1}}{( {k}_{1} t + {k}_{0} )} ) ( 1 + \frac{2}{log ( {k}_{1} t + {k}_{0} )} ) ] {W}_{d} + {C}_{e} \frac{{dv}_{in}}{dt} \qquad ( 78 )$$

In the scenario where C_{T}=C_{c}, we get:

$$\frac{{dW}_{d}}{dt} = - [ ( \frac{{k}_{1}}{( {k}_{1} t + {k}_{0} )} ) ( 1 + \frac{2}{log ( {k}_{1} t + {k}_{0} )} ) ] {W}_{d} + \frac{{dv}_{in}}{dt} \qquad ( 79 )$$

Then, we can formulate a discrete-time weight update as:

$$\frac{Δ {W}_{d} ( n )}{Δ t} = - {k}_{1} ( 1 + \frac{2}{log ( {k}_{1} Δ tn + {k}_{0} )} ) ( \frac{1}{{k}_{1} Δ tn + {k}_{0}} ) {W}_{d} ( n - 1 ) + \frac{Δ {v}_{in} ( n )}{Δ t} \qquad ( 80 )$$

$${W}_{d} ( n ) = [ 1 - ( 1 + \frac{2}{log ( {k}_{1} Δ tn + {k}_{0} )} ) ( \frac{1}{n + \frac{kv}{{k}_{1} Δ t}} ) ] {W}_{d} ( n - 1 ) + ( {v}_{in} ( n ) - {v}_{in} ( n - 1 ) ) \qquad ( 81 )$$

where n represents the number of patterns observed and Δt is the duration of the input pulse. Let us denote the weight decay term as:

$$α ( n ) = [ 1 - ( 1 + \frac{2}{log ( {k}_{1} Δ tn + {k}_{0} )} ) ( \frac{1}{n + \frac{{k}_{0}}{{k}_{1} Δ t}} ) ] \qquad ( 82 )$$

Thus, we obtain the weight update equation with respect to number of patterns observed as

$$α ( n ) = [ 1 - ( 1 + \frac{2}{log ( {k}_{1} Δ tn + {k}_{0} )} ) ( \frac{1}{n + \frac{{k}_{0}}{{k}_{1} Δ t}} ) ] \qquad ( 83 )$$

Then the equation can be unfolded as follows:

$${W}_{d} ( n ) = α ( n ) {W}_{d} ( n - 1 ) + ( {v}_{in} ( n ) - {v}_{in} ( n - 1 ) ) \qquad ( 84 )$$

$${W}_{d} ( n - 1 ) = α ( n - 1 ) {W}_{d} ( n - 2 ) + ( {v}_{in} ( n - 1 ) - {v}_{in} ( n - 2 ) ) \qquad ( 85 )$$

and so on, until . . .

$${W}_{d} ( 2 ) = α ( 2 ) {W}_{d} ( 1 ) + ( {v}_{in} ( 2 ) - {v}_{in} ( 1 ) ) \qquad ( 86 )$$

$${W}_{d} ( 1 ) = α ( 1 ) {W}_{d} ( 0 ) + ( {v}_{in} ( 1 ) - {v}_{in} ( 0 ) ) \qquad ( 87 )$$

Assuming the initial condition that W_{d}(0)=0 and x(0)=0, if we multiply each W_{d}(i) with the product of all α(i)s succeeding it and sum them up, we get:

$${W}_{d} ( n ) = ( {v}_{in} ( n ) - {v}_{in} ( n - 1 ) ) + α ( n ) ( {v}_{in} ( n - 1 ) - {v}_{in} ( n - 2 ) ) + α ( n ) α ( n - 1 ) ( {v}_{in} ( n - 2 ) - {v}_{in} ( n - 3 ) ) + … + α ( n ) α ( n - 1 ) … α ( 4 ) α ( 3 ) ( {v}_{in} ( 2 ) - {v}_{in} ( 1 ) ) + α ( n ) α ( n - 1 ) … α ( 3 ) α ( 2 ) {v}_{in} ( 1 ) \qquad ( 88 )$$

This can be generalized as

$${W}_{d} ( n ) = \{ {v}_{in} ( n ) + ( α ( n ) - 1 ) ( {v}_{in} ( n - 1 ) + ( α ( n ) - 1 ) - 1 ) α ( n ) {v}_{in} ( n - 2 ) + … + α ( n ) α ( n - 1 ) …α ( 3 ) α ( 2 ) - 1 ) {v}_{in} ( 1 ) \} \qquad ( 89 )$$

$${W}_{d} ( n ) = {\sum }_{i = 1}^{n - 2} \{ ( α ( i + 1 ) - 1 ) ( {\prod }_{j = i + 2}^{n} α ( j ) ) {v}_{in} ( i ) \} + ( α ( n ) - 1 ) {v}_{in} ( n - 1 ) + {v}_{in} ( n ) \qquad ( 90 )$$

Therefore, each weight W_{d}(n) at time instance n can be represented as a summation of the product of synaptic modifications or patterns vᵢₙ(n−1), vᵢₙ(n−2) . . . vᵢₙ(1) and cumulative decay rate r_{c}, (n, n−1), r_{c}, (n, n−2), . . . r_{c}(n, 1) for instances preceding n as:

$${W}_{d} ( n ) = {\sum }_{i = 1}^{n - 1} {v}_{in} ( i ) {r}_{c} ( n , i ) + {v}_{in} ( n ) \qquad ( 91 )$$

$$where$$

$${r}_{c} ( n , i ) = ( α ( i + 1 ) - 1 ) ( {\prod }_{j = i + 2 , j \leq n}^{n} α ( j ) ) \qquad ( 92 )$$

Then, for a network of N synapses, each indexed as W_{d}(a, n) (where a=1, N), with the input applied to the a^{th} synapse after n patterns represented by vᵢₙ(a, n), the signal strength for the p^{th} update (where p<n) tracked after n patterns is given by:

$$S ( n , p ) = \frac{1}{N} 〈 {\sum }_{a = 1}^{n} {W}_{d} ( a , n ) {v}_{in} ( a , p ) 〉 \qquad ( 93 )$$

where angle brackets denote averaging over the ensemble of all of the random uncorrelated patterns seen by the network. Since the signal corresponding to a certain update is essentially determined by the overlap of the associated history of synaptic modifications with the present synaptic weights, by substituting (91) into (93), we get the signal strength of the p^{th} update as:

$$S ( n , p ) = \frac{1}{N} 〈 {\sum }_{a = 1}^{n} {W}_{d} ( a , n ) {v}_{in} ( a , p ) 〉 = {r}_{c} ( n , p ) = ( α ( p + 1 ) - 1 ) {\prod }_{j = p + 2}^{n} α ( j ) \qquad ( 94 )$$

Given that in (82), k₀= [symbol] (10¹⁹) and k₁= [symbol] (10¹⁶), the term

$$( 1 + \frac{2}{ln ( {k}_{1} Δ tn + {k}_{0} )} ) \approx 1 ,$$

the above equation can be simplified as follows:

$$S ( n , p ) = \frac{- 1}{p + 1 + γ} ( 1 - \frac{1}{p + 2 + γ} ) ( 1 - \frac{1}{p + 3 + γ} ) … ( 1 - \frac{1}{n - 1 + γ} ) ( 1 - \frac{1}{n + γ} ) \qquad ( 95 )$$

$$S ( n , p ) = \frac{- 1}{n + γ}$$

where

$$γ = \frac{{k}_{0}}{{k}_{1} Δ t} .$$

This leads to the following expression for signal power:

$${S}^{2} ( n , p ) = \frac{1}{{( n + γ )}^{2}} \qquad ( 96 )$$

By assuming that the weight W_{d}(n) is uncorrelated from the input pattern vin(n) and that the inputs vᵢₙ(1), vᵢₙ, (2) . . . vᵢₙ(n) are all uncorrelated from each other, we can obtain the noise power associated with the retrieved signal (which is essentially the variance of the retrieved signal). It is measured as the summation of the power of all signals tracked at n except for the retrieval signal of the p^{th} pattern and is expressed as:

$${v}^{2} ( n , p ) = \frac{1}{N} {\sum }_{i = 1 , i \neq p}^{n} {S}^{2} ( n , i ) \qquad ( 97 )$$

By incorporating the retrieval signal into the summation in (97) we can obtain a more tractable analytical expression for noise power despite the marginal error it introduces. The resulting expression is given by

$${v}^{2} ( n , p ) = \frac{1}{N} {\sum }_{i = 1}^{n} {S}^{2} ( n , i ) = \frac{n}{N {( n + γ )}^{2}} \qquad ( 98 )$$

Based on the value of n in comparison to γ, we obtain two trends for the noise profile. When γ>>n,

$$v ( n , p ) = \frac{1}{\sqrt{N}} ( \frac{\sqrt{n}}{γ} ) \qquad ( 99 )$$

which implies that noise increases with increase in updates initially. On the other hand, when γ<<<n,

$$v ( n , p ) = \frac{\sqrt{n}}{\sqrt{N} n} = \frac{1}{\sqrt{N}} ( \frac{1}{\sqrt{γn}} ) \qquad ( 100 )$$

which implies that noise falls with increase in updates in the later stages. The signal-to-noise ratio (SNR) of a network of size N can then be obtained as:

$$S N R ( n , p ) = \sqrt{\frac{{S}^{2} ( n , p )}{{v}^{2} ( n , p )}} = \sqrt{\frac{N}{n}} \qquad ( 101 )$$

### DISCUSSION

This disclosure describes a differential FN quantum-tunneling based synaptic device that can exhibit near-optimal memory consolidation that has been previously demonstrated using only algorithmic models. This device, called an FN-synapse, like its algorithmic counterparts, stores the value of the weight and a relative usage of the weight that determines the plasticity of the synapse. Similar to algorithmic consolidation models, an FN-synapse, ‘protects’ important memory by reducing the plasticity of the synapse according to its usage for a specific task. Unlike its algorithmic counterparts like the cascade or EWC models, the FN-Synapse doesn't require any additional computational or storage resources. In EWC models, memory consolidation in continual learning is achieved by augmenting the loss function using penalty terms that are associated with either Fisher information or the historical trajectory of the parameter over the course of learning. Thus, the synaptic updates require additional pre-processing of the gradients, which in some cases could be computationally and resource intensive. FN-synapse on the other hand, does not require any pre-processing of gradients and instead can exploit the physics of the device itself for synaptic intelligence and for continual learning. For some benchmark tasks, it has been shown an FN-synapse network shows better multi-task accuracy compared to other continual learning approaches. This leads to the possibility that the intrinsic dynamics of the FN-synapse could provide important clues on how to improve the accuracy of other continual learning models as well.

FIGS. 6A and 6B also show the importance of the learning algorithm in fully exploiting the available network capacity. While the entropy of the FN-synapse weights for the output layer is relatively high, the entropy of the weights of the input layer is still relatively low, implying most of the input layer weights remain unused. This is an artifact of vanishing gradients in a standard backpropagation based neural network learning. Thus, improved backpropagation algorithms may mitigate this artifact and, in the process, enhance the capacity and the performance of the FN-synapse network. In FIG. 14 it is shown that FN-synapse based neural network is able to maintain its performance even when the network size is increased. Thus, it is possible that the network becomes capable of learning more complex tasks due to increase in overall plasticity of the network while ensuring considerably better retention than neural networks with traditional synapses.

In addition to being physically realizable, the FN-synapse implementation also allows interpolation between a steady state consolidation model and the EWC consolidation models. This is important because it is widely accepted that the EWC model can potentially suffer from blackout catastrophe as the learning network approaches its capacity. During this phase, the network becomes incapable of retrieving any previous memory as well as is unable to learn new ones. Steady state models such as the cascade consolidation models and SGD-based continuous learning models avoid this catastrophe by gracefully forgetting old memories. As shown in FIG. 5A, an FN-synapse network, through use of a global modulation factor, is able to interpolate between the two models. In fact, the results in FIGS. 5A and 5B show that not only the number of patterns/memories retained in an FN-synapse network under modulation profile m₂(t) at steady state is higher compared to that of a high-complexity cascade model for a network size of N=1000 synapses. This attribute may provide significant improvements for continuous learning of a large number of tasks.

The interpolation property of FN-synapse could mimic some attributes of metaplasticity observed in biological synapses and dendritic spines. The role of metaplasticity, the second-order plasticity of a synapse which assigns a task-specific importance to every successive task being learned, is widely accepted as the fundamental component of neural processes key to memory and learning in the hippocampus. Since unregulated plasticity leads to runaway effects resulting in previously stored memories to be impaired at saturation of synaptic strength, metaplasticity serves as a regulatory mechanism which dynamically links the history of neuronal activity with the current response. The FN-synapse mimics the same regulatory mechanism through the decaying term r(t) that considers the history of usage or neuronal activity to determine the plasticity of the synapse for future use as well as prevents runaway effects by making the synapses rigid at saturation.

The on-device memory consolidation in FN-synapse can not only minimize the energy requirements in continual learning tasks, additionally, the energy required for a single synaptic weight update is also lower than memristor-based synaptic updates for a fixed precision of update. This attribute has been validated and the update energy was estimated to be as low as 5f J increasing up to 2.5p J depending on the status of the FN-synapse and the desired change in synaptic weights. Note that the energy required to change the synaptic weight is derived from the FN-tunneling current and not from the electrostatic energy used for charging the coupling capacitor. Thus, by designing more efficient charge-sharing techniques across the coupling capacitors the energy-efficiency of FN-synaptic updates can be significantly improved. Furthermore, when implemented on more advanced silicon process nodes, the capacitances could be scaled which can improve the energy-efficiency of FN-synapse by an order of magnitude. Compared to memristor-based synapses, the FN-synapse can also exhibit high endurance 10⁶-10⁷ cycles without any deterioration. However, the key distinction lies in terms of the dynamic range of the stored weights. Generally, a single memristor has two distinct [symbol] (1/\sqrt{t}) conductive states (corresponding to “0” or “1”) which give each device a 1-bit resolution. When used in a crossbar array, highly-dense designs can reach densities up to 76.5 nm² per bit, for example, when a 3-D memristor array was constructed using Perovskite quantum wires. The dynamic range or resolution of such designs is determined by the number of memristive devices that can be packed into the smallest feasible physical form factor. If we consider multi-level memristors instead, the resolution per memristor can reach up to 3-5 bits depending on the number of stable distinguishable conductive states. In comparison, the dynamic range of the FN-synapse (a single device) is considerably higher as it is determined by the number of electrons stored on the floating-gates which in-turn is determined by the FN-synapse form-factor and the dielectric property of the tunneling barrier. Thus, theoretically, the dynamic range and the operational-life of the FN-synapse seems to be constrained by the single-electron quantization. However, at low-tunneling regimes, the transport of single electrons across the tunneling barrier becomes probabilistic where the probability of tunneling is now modulated by the external signals X(t) and m(t). Herein, we show that a stochastic dynamical system model emulating the single-electron dynamics in the FN-synapse can produce consolidation characteristics for the benchmark random input patterns experiment for an empty network. The SNR still follows the power-law curve and the FN-synapse network continues to learn new experiences even if the synaptic updates are based on discrete single-electron transport. A more pragmatic challenge in using the FN-synapse will be the ability of the read-out circuitry to discriminate between the changes in floating-gate voltage due to single-electron tunneling events. For the magnitude of the floating-gate capacitance, the change in voltage would be in the order of 100 nV per tunneling event. A more realistic scenario would be to measure the change in voltage after 1,000 electron tunneling events which would imply measuring 100 μV changes. Although this will reduce the resolution of the stored weights/updates to 14 bits, recent studies have shown that neural networks with training precisions as low as 8 bits and networks with inference precisions as low as 2-4 bits are often capable of exhibiting remarkably good learning abilities. In FIG. 15, it is shown that for the split-MNIST task, the performance of the FN-synapse based neural network remains robust even in the presence of 5% device mismatch.

Another point of discussion is whether the optimal decay profile r(t)≈ [symbol] (1/t) can be implemented by other synaptic devices, in particular, the energy-efficient memristor-based synapses that have been proposed for neuromorphic computing. Recent works using memristive devices have demonstrated on-device metaplasticity, however, achieving an optimal decay profile would require additional control circuitry, storage, and read-out circuits. In this regard, the FN-synapse may represent one of the few, if not the only class of synaptic devices that can achieve optimal memory consolidation on a single device.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A synaptic array comprising:
a plurality of Fowler-Nordheim (FN) synapses, each FN synapse connected to at least one other FN synapse of the plurality of FN synapses to form a network, each FN synapse includes a pair of FN tunneling devices each including a floating gate,
wherein each FN synapse is operable to store a synaptic weight as a differential voltage across the floating gates of its FN tunneling devices and to implement synaptic memory consolidation.

2. The synaptic array of claim 1, wherein each FN synapse of the plurality of FN synapses is operable to store a historical usage statistic on that FN synapse in addition to the synaptic weight.

3. The synaptic array of claim 2, wherein the historical usage statistic comprises an adaptive measure of that FN synapse's synaptic weight's uncertainty or importance.

4. The synaptic array of claim 1, wherein each FN synapse of the plurality of FN synapses is connected to at least one other FN synapse of the plurality of FN synapses to form an artificial neural network.

5. The synaptic array of claim 4, wherein the artificial neural network is a multi-layer perceptron.

6. The synaptic array of claim 1, wherein the FN tunneling devices comprise polysilicon, silicon-di-oxide, and n-well layers.

7. The synaptic array of claim 6, wherein the floating gate of each FN tunneling device comprises a polysilicon layer.

8. The synaptic array of claim 1, wherein an initial charge on the floating gate of each FN tunneling device is programmable using hot-electron injection, quantum-tunneling, or a combination of both.

9. The synaptic array of claim 1, wherein each FN synapse includes an input operable to receive a signal to adjust a plasticity of the FN synapse.

10. The synaptic array of claim 9, wherein the signal to adjust the plasticity of the FN synapse configures the FN synapse to mimic a cascade model or a task-specific consolidation.

11. The synaptic array of claim 9, wherein the input further comprises a coupling capacitor.

12. A Fowler-Nordheim (FN) synapse for use in a synaptic array, the FN synapse comprising:
a first FN tunneling device;
a second FN tunneling device; and
an input coupled to the first and second FN tunneling devices and operable to adjust a plasticity of the FN synapse in response to a signal applied to the input.

13. The FN synapse of claim 12, wherein the input comprises a coupling capacitor.

14. The FN synapse of claim 12, wherein the signal to adjust the plasticity of the FN synapse configures the FN synapse to mimic a cascade model or a task-specific consolidation.

15. The FN synapse of claim 12, wherein the first tunneling device includes a first floating gate and the second tunneling device includes a second floating gate.

16. The FN synapse of claim 15, wherein the FN synapse is operable to store a synaptic weight as a differential voltage across the first floating gate and the second floating gate and to implement synaptic memory consolidation.

17. The FN synapse of claim 16, wherein the FN synapse is operable to store a historical usage statistic in addition to the synaptic weight.

18. The FN synapse of claim 17, wherein the historical usage statistic comprises an adaptive measure of the synaptic weight's uncertainty or importance.

19. The FN synapse of claim 12, wherein the first tunneling device and the second tunneling device each comprise polysilicon, silicon-di-oxide, and n-well layers.

20. The FN synapse of claim 19, wherein the first floating gate and the second floating gate each comprises a polysilicon layer.
